(19) United States
(12) Patent Application Publication
(10) Pub. No.: US 2013/0075152 A1
(43) Pub. Date: Mar. 28, 2013

(54) PHOTO-VOLTAIC (PV) WIRE MANAGEMENT SYSTEM OR PV CONDUIT

(71) Applicant: JASON OLIVER MAZZONE, Newtown Square, PA (US)

(72) Inventor: JASON OLIVER MAZZONE, Newtown Square, PA (US)

(21) Appl. No.: 13/240,693

(22) Filed: Sep. 22, 2011

(51) Int. Cl. H02G 3/02

(52) U.S. Cl. 174/481

(57) ABSTRACT

The invention disclosed herein relates to an integrated conduit with optional embedded conductors and connectors, specifically designed to integrate into or function as a modern day solar power array. This conduit system or “solar conduit” or “PV conduit” is designed to organize, contain, protect and route the wires, conductors, tubing, components and/or connectors commonly found in a solar power array, especially a solar photovoltaic (PV) array.

### RELATED APPLICATIONS

This application claims priority to U.S. Non-Provisional Application Ser. No. 13/240,693, filed Sep. 22, 2011, and is herein incorporated by reference.

### FIELD OF INVENTION

The present invention relates to an integrated conduit for solar power arrays, which is a system of components assembled together for the purpose of organizing, routing and protecting the conductors, connectors, wires and/or tubing originating from a single or plurality of solar modules with a variety of power management hardware. These wires, connectors, and tubes etc. may be originating from a single or plurality of PV modules, hot-water modules, PV module junction boxes, micro-inverters and/or PV module control modules The invention further relates to a method of installing the conduit systems directly to a variety of solar arrays using a unique system of integrated fasteners that attach the conduit to a solar array.

### DESCRIPTION OF RELATED ART

Solar arrays are typically constructed using mounting systems that are comprised of “rails” or “racking” and “module clamp” components that secure the solar modules to the supporting racking or rails. The rails are usually secured, using additional hardware, to a roof or to a structure on the ground, creating a “roof mount” or “ground mount” array. These types of racking systems are well known in the art and contain wiring, tubing and connectors that route the power produced by the solar modules to certain components like storage tanks, combiner boxes, inverters or PV control modules, electricity distribution panels and then, in the case of solar photo-voltaics (PV), to the utility grid. Conventional methods of mounting PV modules include fastening them to the rails using “mid-clamps” and “end-clamps” that install with stainless steel nut and bolt hardware.

There is a clear need for an integrated solar conduit system that is able to protect and route the plurality of wires, conductors, connecters and tubing typically found in a solar array, specifically a PV array. It is considered favorable for this system to be inexpensively manufactured and easily installed in a “plug and play” manner.

### SUMMARY OF THE INVENTION

It is an object of the present invention to overcome and/or reduce the aforementioned limitations of the prior art.

As shown in the drawing set, the wire management system of the present invention comprises multiple components assembled or integrated together in order to create or integrate a conduit or race-way to virtually any solar power array.

The invented components are designed to integrate into/onto a solar power array in an assortment of installation locations (FIG. 1A) by attaching the conduit to the racking, or rails, module frames, or frameless modules by using the assortment of hardware provided in the invention (FIG. 5D). Depending on the location on the array, the hardware in the system changes accordingly to accommodate different environments on the array.

The variety of conduit and attachment design features of the invented wire management system can be integrated together to enable the installer to easily elevate, attach, organize, protect and route the wires/components of a PV array directly to the array; in a plurality of installation scenarios. This invented system is specifically designed to elevate, route, protect, and attach the PV wires directly to the array, in close proximity to the solar modules, in an aesthetic and architectural manner. This system allows the installer to easily attach a wire management system directly to:
a) the edge of a structural “rack” rail, typically made of extruded steel or aluminum (1A.2).
b) the edge of a PV module frame rail (1A7), typically made of aluminum.
c) the aluminum or plastic array “racking” or “ rails” that support the solar modules that make up a typical solar array (1A.6).
d) the edge of a frameless solar PV module (1A.3).

Certain extrusion profiles of the conduit system provided interact with certain components of a typical PV array illustrated throughout the drawing set in a new and unique manner. These unique components are designed to be utilized to create a conduit like environment using the least amount of material and labor, efficiently and effectively providing a wire management system.

The invented system may be constructed using certain combinations of component features found in the invention as well as in the field of PV installation and the related arts such as solar hot water and natural daylighting systems. The system may be constructed using certain manufacturing techniques such as plastic extrusion, metal extrusion, injection molding, blow molding, etc. and by forming, rolling, bending, stamping, extruding, casting, molding plastic or composite etc. materials.

### DESCRIPTION OF THE ATTACHED DRAWINGS

FIG. 1A shows the various installation locations of the invented conductor management system shown.
a) 1A.1 depicts a typical solar array, as seen from above in plan view, including a plurality of solar modules 92 fastened onto racking rails 98 using end clamps 94 and mid clamps 93. Four sectional viewpoint “cut lines” are depicted using dashed lines and arrows indicating the sight line directions. The viewpoints are labeled with the numbers 1,2,3 and 4 inside the arrows.
b) 1A.2 depicts a generic structural rail 90 comprising at least two perpendicular rails which is extruded to varying lengths. These rails may have varying profiles in the field of art, this illustration is intended to show a simplest rail form.
c) 1A.3 depicts the edge 99 of a “frameless” PV module 92 which has no additional frame 97 around the perimeter of the module 92.
d) 1A.4 depicts a magnified view of a section of 1A.1 showing a typical mid clamp 93 installed onto a solar module 92 and fastening the module to a racking rail 98.
e) 1A.5 depicts a magnified view of a section of 1A.1 showing a typical end-clamp 94 installed onto a solar module 92 and fastening the module to a racking rail 98
f) 1A.6 depicts a section of a racking rail 98 outlined using an oval dashed line. Adjacently depicted above is a section of a solar module 92 with a module frame 97 mounted in its respective location on top of the racking rail 98.
g) 1A.7 depicts a section of a solar module 92 frame rail 97 outlined using an oval dashed line.

FIG. 1B depicts a section drawing from viewpoint 1 of 1A.1 cut at the mid-clamp 93 between two typical solar PV modules 92 mounted on a typical solar racking rail 98. Two preferred models (1B.1, 18.2) of the system are illustrated in their respective installation locations. Two sectional view cut lines are shown using dashed lines and arrows with the number 3 and 4 inside.
a) 1B.1 depicts an arc conduit 100 shown installed onto the racking rail 98 using an invented integrated grounding washer 111 integrated into a conduit hanger 110 and then fastened to the array by installing the grounding washer 111/hager 110 component between the PV module frame and racking rail surface under the mid-clamp 93 using the mid clamp bolt 89 to compress the two surfaces together, thereby mounting the solar module 92, grounding said module to the racking rail 98 and installing a conduit hanger 110. The conduit hanger 110 then cradles and clasps the “arc” shaped conduit 100.
b) 1B.2 depicts a second “c” shaped conduit 101 installed onto the frame rail edge 97 of the PV module 92 using an elongated mouth shaped fastener component 107. This section drawing also illustrates a PV lead wire 106 originating from a PV module junction box 91 being routed into the raceway 103 through the access slit 115 of the “c” shaped conduit 101.

FIG. 1C depicts a section drawing from viewpoint 3 from 1A.1 of the rear of a typical solar array with conduit 101 shown installed on the array using fastener 107.
a) 1C.1 depicts the racking rail 98 and solar modules 92 installed with the conduit 101 of FIG. 1B.2 and a conduit coupler 112 installed in its respective location.
b) 1C.2 shows the optional semicircle access holes 116 located along the length of the conduit near the centers of the solar modules to accept the PV leads 106 that originate from the PV module junction boxes 91.

FIG. 1D depicts a section drawing from viewpoint 3 from 1A.1 of the rear of a typical solar array with conduit 101 shown installed on the array using fastener 107.
a) 1D.1 is a magnified portion of 1D.3 showing a conduit 101 with an integrated coupler 112 in which the conduit fits directly into the adjacent conduit as shown.
b) 1D.2 is a magnified portion of 1D.3 showing a conduit 101 installed using an elongated mouth shaped fastener 107 onto the PV module frame rail 97.

FIG. 1E depicts a section drawing from viewpoint 3 from 1A.1 of the rear of a typical solar array with conduit 101 shown installed on the array using fastener 107.
a) 1E.1 is a magnified portion of 1E.3 showing a conduit 101 installed using an elongated mouth shaped fastener 107 onto PV module frame rail 97. 1E.1 also illustrates an external coupler 112 designed to install around the C shaped conduit and snap into place, forming a complete raceway between module gaps.
b) 1E.2 is a magnified portion of 1E.3 showing a conduit 101 installed using an elongated mouth shaped fastener 107 onto the PV module frame rail 97.

FIG. 1F depicts a section drawing from viewpoint 3 from 1A.1 of the rear of a typical solar array with conduit 100 shown installed on the array using fastener 107.
a) 1F.1 is a magnified portion of 1F.3 showing the conduit 100 installed onto module frame rail 97 using the elongated mouth shaped fastener 107. Drawing 1F.1 also illustrates the optional semicircle access holes 116 located along the length of the conduit near the centers of the solar modules to accept the PV leads 106 that originate from the PV module junction boxes 91.
b) 1F.2 is a magnified portion of 1F.3 showing two conduit hangers 110 installed onto the module frame rails 97 of two adjacently located PV modules 92 using the mouth shaped fastener 107 turned perpendicularly and hanging conduit 101. This type of conduit is further detailed in FIG. 3C.

FIG. 1G depicts a section drawing from viewpoint 4 from 1A.1 of the rear of a typical solar array with conduit 100 shown installed on the rack rail 98 using conduit hangers 110.
a) 1G.1 is a magnified portion of 1G.3 showing the conduit hanger 110 installed at the mid clamp 93 using a bolt and integrated grounding washer 111 to fasten the hanger 110 to the array.
b) 1G.2 is a magnified portion of 1G.3 showing the conduit hanger 110 installed at the end clamp 94 using a bolt to fasten the hanger 110 to the array.

FIG. 1H depicts four installation scenarios using the various conduit, fastener and grounding hardware provided in the invented system illustrated in axonometric view with the racking rail 98 or module frame rail 97 shown as dashed lines. Additionally, the raceway 103 or wire way 103 created by the conduit is illustrated in the drawings.
a) 1H.1 depicts a racking rail 98 with conduit 100 shown fastened using an elongated tab fastener 108 that is inserted into the rail channel 95 from the end and slid down the rail.
b) 1H.2 depicts a racking rail 98 with conduit 101 shown fastened using conduit hanger 110 with grounding washer 111. As illustrated, the bolt is inserted through the grounding washer hole (typically centrally located). The grounding washer is placed under two adjacent PV modules 92 and compressed using the bolt to clamp the module frames 97 down. The grounding washer 111 has “tooth” components that scratch or bite throught the anodized module frames to form a conductive bond between module frames 97 and racking rail 98.
c) 1H.3 depicts a solar module frame rail 97 with conduit 101 installed using fastener 107 and reinforcing clip 114.
d) 1H.4 depicts a solar module frame rail 97 with conduit 100 installed using fastener 107.

FIG. 1I depicts six installation scenarios using conduit 101 and 102 integrated with fastener 107 to attach the conduit onto racking rail 90 or PV module 92, 99.
a) 1I.1 depicts an axonometric view of conduit 101 installed onto module edge 99 creating raceway 103. Additionally, an optional bead of adhesive 117 is shown meant to reinforce the bond between fastener and rail.
b) 1I.2 depicts an elevation view of the installation scenario illustrated in 1I.1.
c) 1I.3 depicts an axonometric view of conduit 101 installed onto rack rail edge 90 creating raceway 103. Additionally, an optional bead of adhesive 117 is shown meant to reinforce the bond between fastener and rail.
d) 1I.4 depicts an elevation view of the installation scenario illustrated in 1I.3.
e) 1I.5 depicts an axonometric view of conduit 102 with integrated conductors 104 installed onto frameless module edge 99 with integrated connector 130. Additionally, to fully enclose the raceway 103, a two part snap fitting 113, 125 is provided to clasp the flexible arc conduit 100 closed.
f) 1I.6 depicts an elevation view of the installation scenario illustrated in 1I.5.

FIG. 1J depicts a conduit 102 with integrated conductors 104, 135 and arc component 100 which creates raceway 103 installed onto frameless PV module edge 99 using fastener 107.
a) 1J.1 depicts an elevation view of conduit 102 installed onto a solar module edge 99 with integrated connector 130 relaying current produced by PV layers 96 of PV module 92.
b) 1J.2 depicts a plan view of generic electrical splice 133 and connector 130 components that are used to bond certain integrated conductors 104, 129, 96, 120 together.
c) 1J.3 depicts an axonometric view of the conduit of 1J.1 and splice/connector components of 1J.2 shown in their respective installation scenarios with arrows indicating the direction in which they would be assembled together.

FIG. 2A depicts three section drawings from viewpoint 2 showing installation scenarios of conduit 101 mounted on racking rail 98 using various fasteners.
a) 2A.1 depicts a conduit 101 cradled by a conduit hanger 110 that is fastened to the racking rail 98 with a compressing tab 109 that is installed into the top rail channel 95 directly at any point along the channel 95.
b) 2A.2 depicts a similar conduit and hanger of 2A.1 installed on a side rail channel 95, thereby changing the form of the hanger 110 to accommodate a different location on the rail 98.
c) 2A.3 depicts a racking rail 98 that is extruded using a different profile. In this installation, there is no channel 95 provided in the side of the rail 98. The conduit is attached using a flat tab 108 fastener that is integrated or extruded into the conduit 101 profile and fastened to the rail 98 using a screw 88.

FIG. 2B depicts three section drawings from viewpoints 1 and 2 showing installation scenarios of conduit 101 mounted on racking rail 98 using various fasteners and integrated grounding components.
a) 2B.1 depicts a section drawing from viewpoint 2 of racking rail 98 with two channels 95 shown as being used to fasten the conduit hanger 110 to the rail 98 using a plurality (two) elongated tabs 109. The conduit hanger 110 cradles and secures a conduit 101.
b) 2B.2 depicts a section drawing from viewpoint 1 of racking rail 98, conduit 101 fastened to the rail with a conduit hanger 110 that is secured by inserting a bolt 89 in channel 95 and through a provided hole on the top flat portion of the hanger 110 that mates with the top of the rail 98. The installer then clamps the hanger down by tightening the nut.
c) 2B.3 depicts a section drawing from viewpoint 1 of a similar installation scenario as 2B.2, however the top of the conduit hanger 110 has been replaced with a grounding washer 111 of FIG. 1H.2.

FIG. 2C depicts three section drawings from viewpoint 1 and 2 of three installation scenarios of conduit 100 mounted on racking rail 98 using various fasteners and integrated grounding components.
a) 2C.1 depicts a section drawing from viewpoint 2 of racking rail 98 with conduit 100 installed using elongated tab fastener 108 inserted and slid down channel 95.
b) 2C.2 depicts a section drawing from viewpoint 2 of racking rail 98 with conduit 100 installed using a conduit hanger 110 fastened using a bolt and nut as shown. The conduit 100 and hanger 110 components illustrated herein have integrated two part snap fittings 125,113 that create a fully enclosed raceway 103 once snapped shut.
c) 2C.3 depicts a section drawing from viewpoint 1 of racking rail similar to 2C.2 however the top portion of the hanger 110 has been replaced with an integrated grounding washer 111 and the top snap fitting has been removed.

FIG. 2D depicts three section drawings from viewpoint 1 of three installation scenarios of conduit 100,102,126 integrated onto/into racking 98 using various fasteners, grounding and integrated conductor/connector components.
a) 2D.1 depicts a section drawing from viewpoint 1 of racking rail 98 with a conduit 100 and conduit hanger 110 with integrated grounding washer 111 and snap fittings 113,125. The drawing attempts to illustrate how the grounding washer component may be integrated into the hanger by over-molding the hanger material around the washer 111 to reinforce the hole in which the bolt 89 is inserted through, giving the hanger more structural support.
b) 2D.2 depicts a section drawing from viewpoint 1 showing the versatility of the hanger 110 profile, adapting to an irregular racking rail profile 98. There is an additional snap fitting 113,125 component as well, to provide a fully enclosed raceway.
c) 2D.3 depicts a section drawing from viewpoint 1 showing a PVC or composite racking rail 126 with integrated connectors 132 and conductors 129 designed to accept and mate with provided PV module 92,99 connectors 130 which plug directly into the rail connectors 132 through a weatherproof grommet 136. The module is clamped down using similar bolt and nut components 89 found throughout the system. Certain PV components 120,127,106 may be installed inside the integrated raceway 103 of the racking rail 102. The raceway is accessible through the flexible conduit 100 which is opened and closed using the two part snap fitting 113, 125.

FIG. 2E depicts three section drawings from viewpoints 1 and 2 of three installation scenarios of racking rail 126 using various integrated conduit profiles, conductors and connectors.
a) 2E.1 depicts a section drawing from viewpoint 1 showing a racking rail 126 with conduit 101 integrated into the extrusion profile. Furthermore, the grounding washer 111 has been adapted to connect and bond to a connector 131 which electrically and structurally bonds to a wire conductor 104 embedded or co-extruded into a rail 126 profile.
b) 2E.2 depicts a section drawing from viewpoint 2 showing a racking rail 126 with conduit 100 integrated into the extrusion profile. Furthermore, the embedded conductors 104, 135, 122 are illustrated showing two part connectors 131 that are designed connect and bond electric circuits/leads 106 originating from PV system components to conductors 104, 135, 122 embedded, isolated and insulated in the rail 126.
c) 2E.3 depicts a section drawing from viewpoint 2 showing a racking rail 98, 126 with integrated conduit hanger or “lip” 126. This drawing further illustrates a shelf for a variety of PV components 120. From the PV component, originates a PV lead 106 that is routed to a two part connector 131 designed to route the lead 106 to conductors embedded in the rail 126. The lead 106 and conductors 104 may be used as a ground, positive, negative, neutral or communication cable intended for a variety of system functions.

FIG. 2F depicts two section drawings from viewpoints 1 and 2 of two installation scenarios of racking rails 98 and 126 using various integrated conduit profiles, conductors and connectors.
a) 2F.1 depicts a section drawing from viewpoint 1 of a racking rail 98 that has a conduit component 102 installed using a hanger 110 with integrated connectors 132 and conductors 129. The hanger connectors 132 are designed to accept and bond the PV module junction connectors 130 through the protection of a weatherproof grommet 136. The integrated conductors 129 of the hanger are routed from the module 92 to another connector 132 which is designed to attach or connect to PV leads which may be routed to a variety of PV power management components 120 located in the raceway 103 provided. The raceway is created by the conduit 100 component that is illustrated being secured to the hanger using snap-fitting 113, 125. The entire unit illustrated is shown being clamped together using the nut and bolt assembly. The nut and bolt assembly 89 may be located anywhere on the module. A hole may be drilled through the module 92 to allow this unit to be located under the module 92 instead of at a mid-clamp 93 location.
b) 2F.2 depicts a section drawing from viewpoint 1 of a racking rail 98 with conduit 101 installed using a tab fastener 108 that has integrated connectors 132 and conductors 104 designed to accept PV lead connecters 106 and route the current through an embedded conductor 104 in the tab fastener 108. The drawing further illustrates an embedded PV component 127 that may be located in the rail that manages the current originating from the PV leads.

FIG. 3A depicts a section drawing from viewpoint 3 showing a two versions of conduit model 101 installed on a solar module frame 97 using an elongated mouth shaped fastener with teeth features and a reinforcing clip 114.

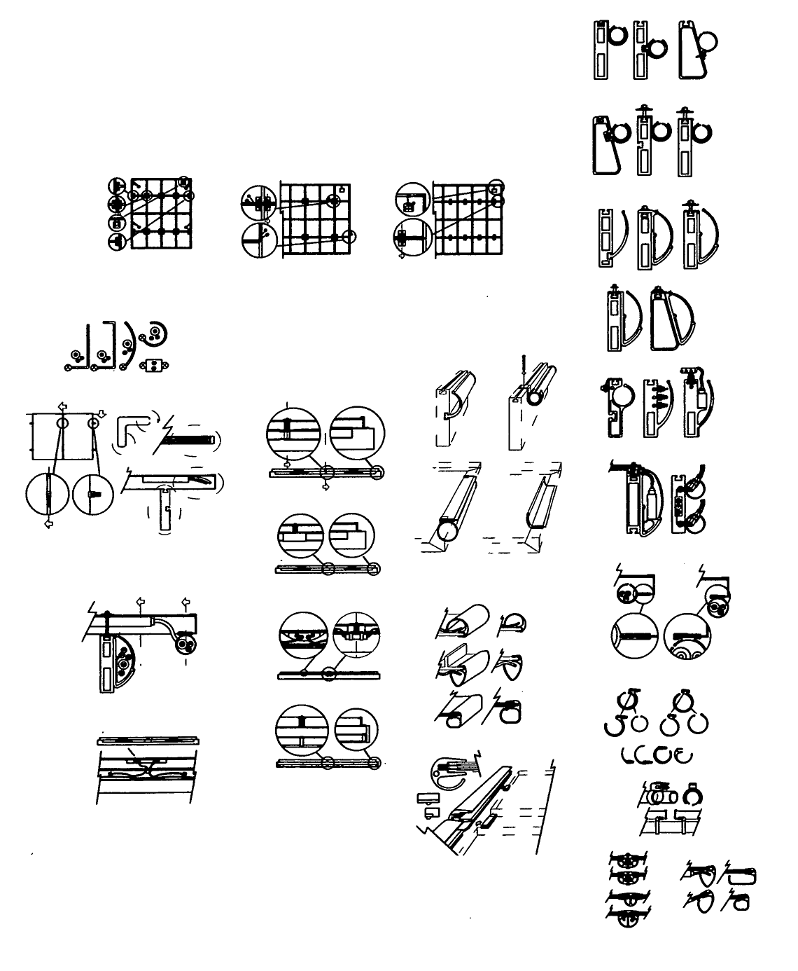

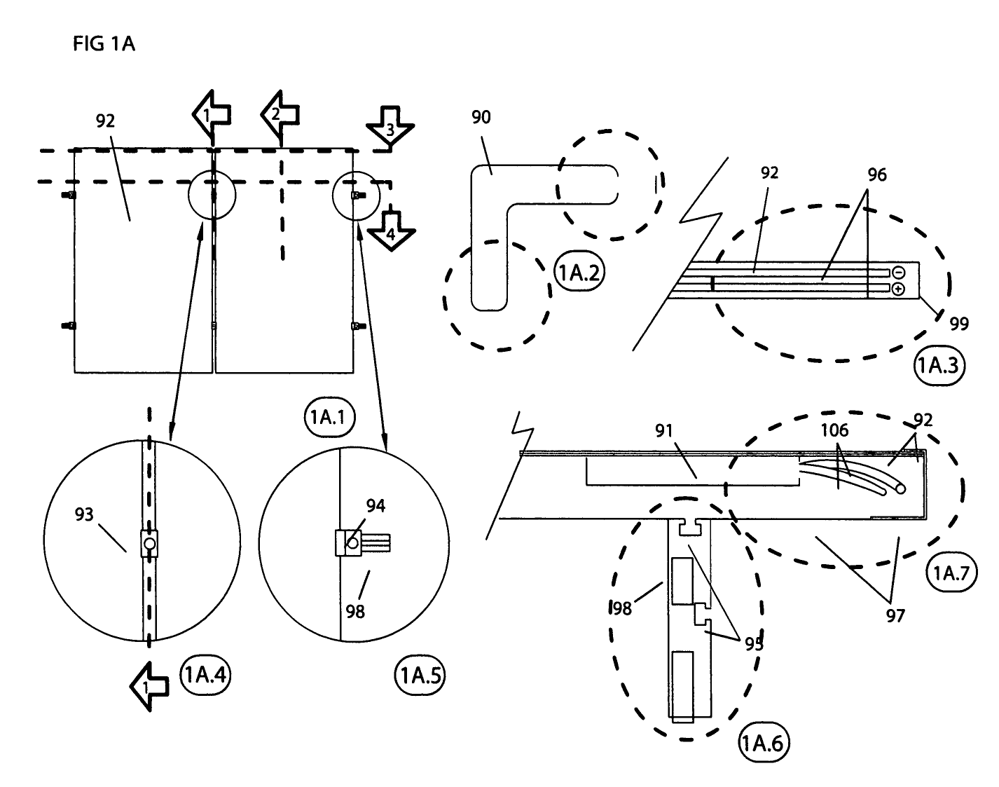

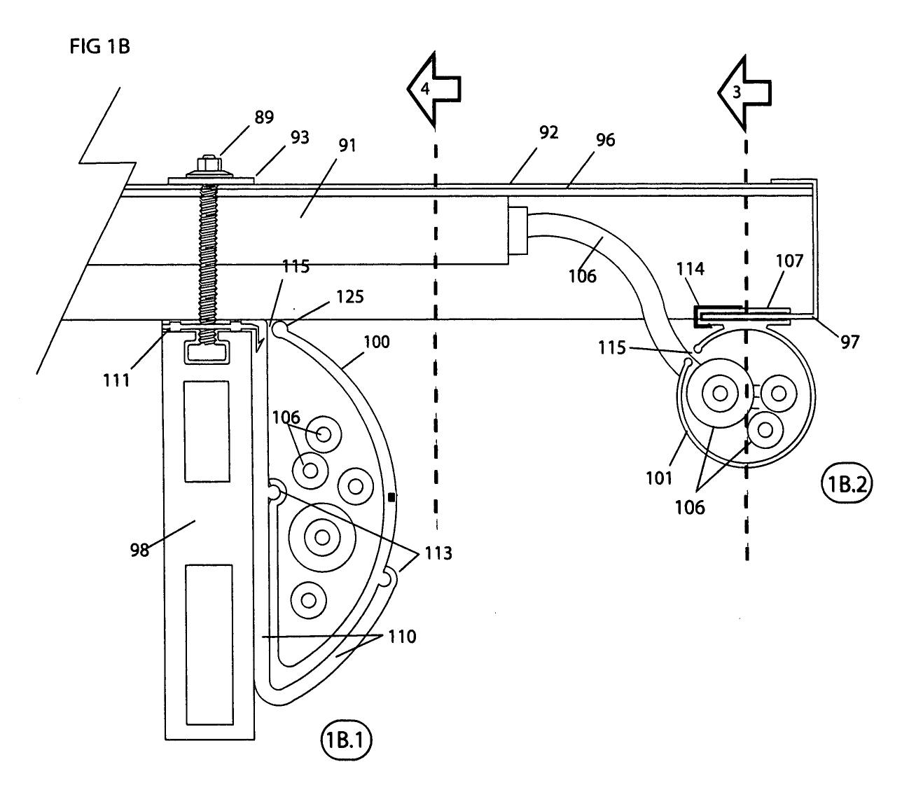

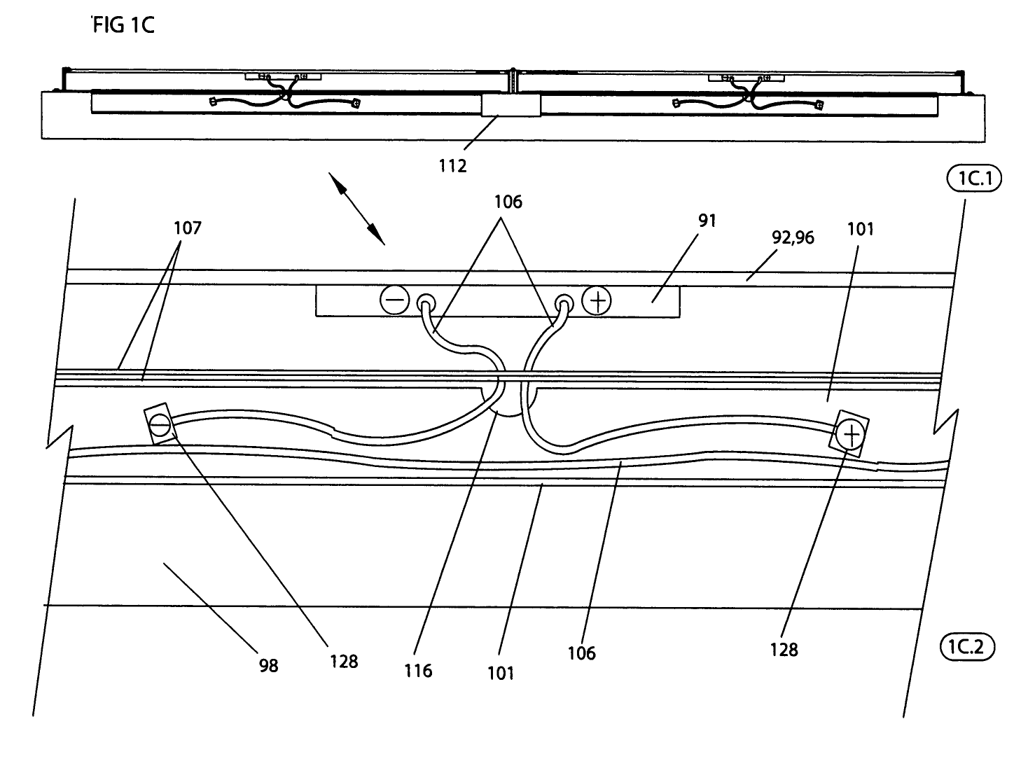

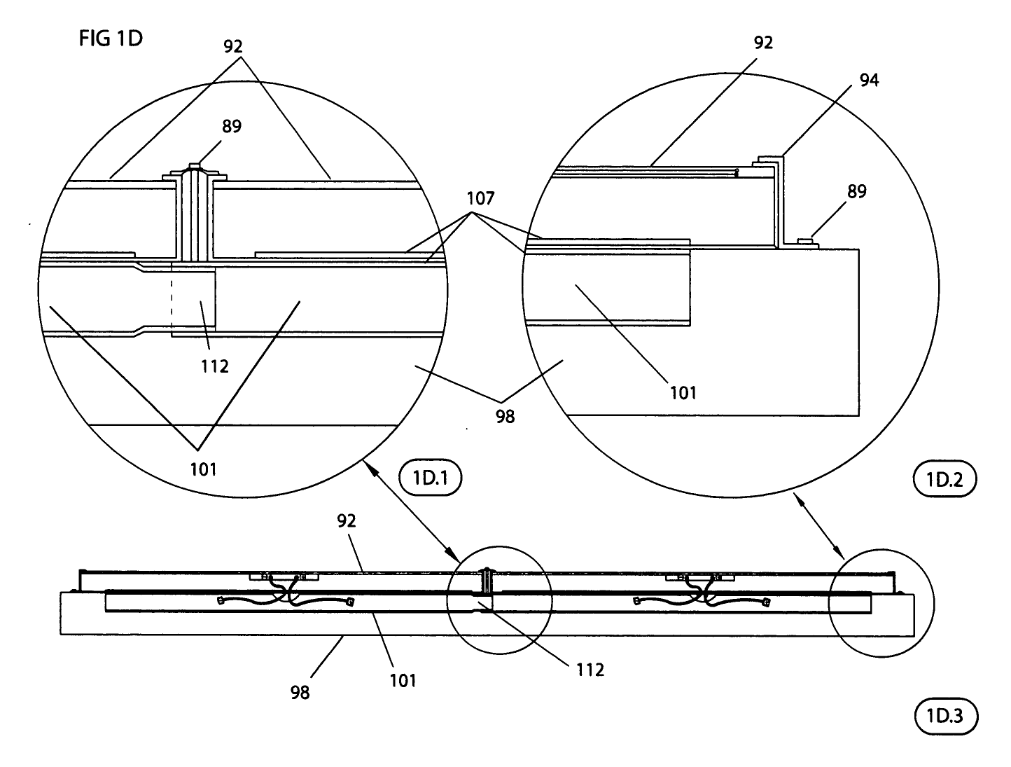

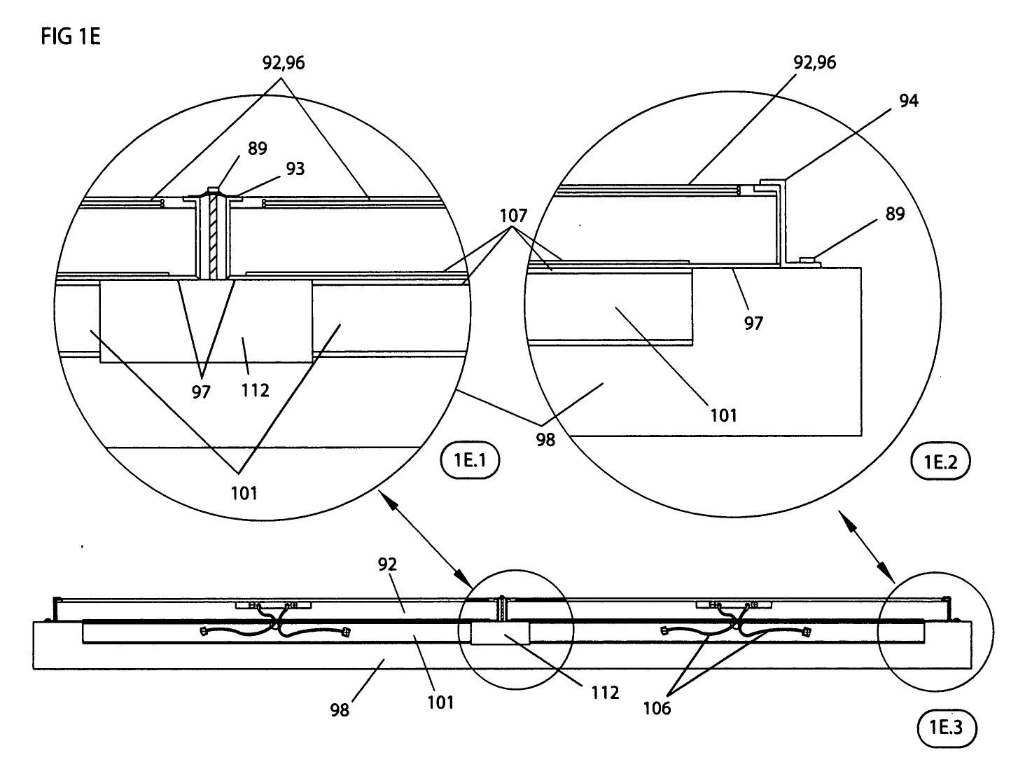

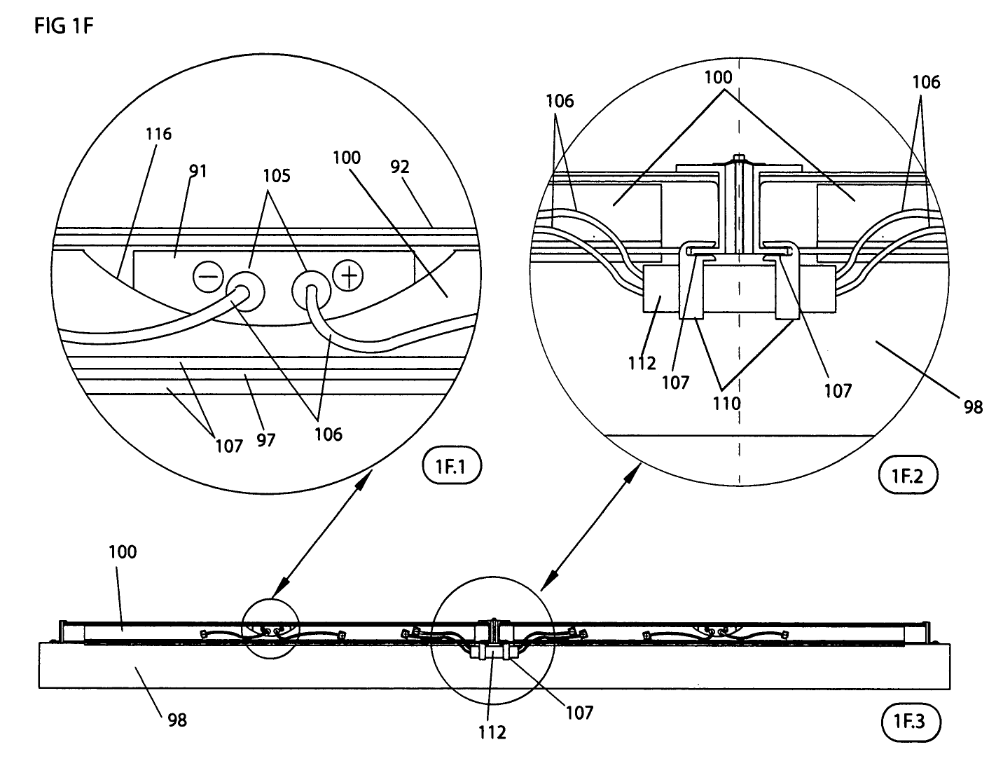

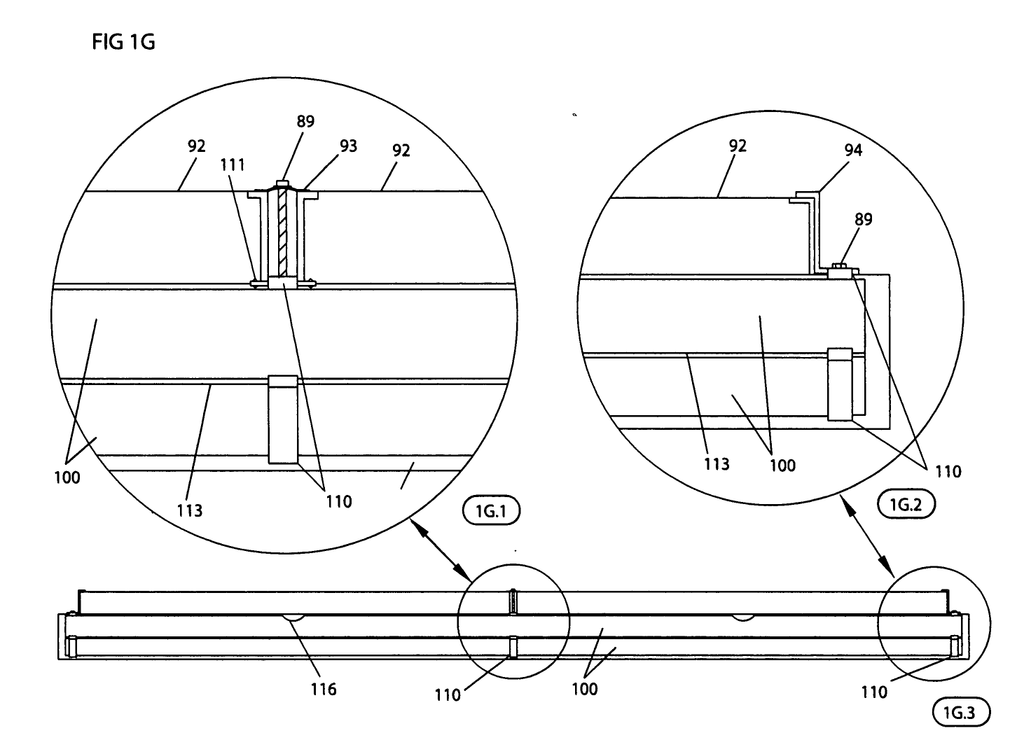

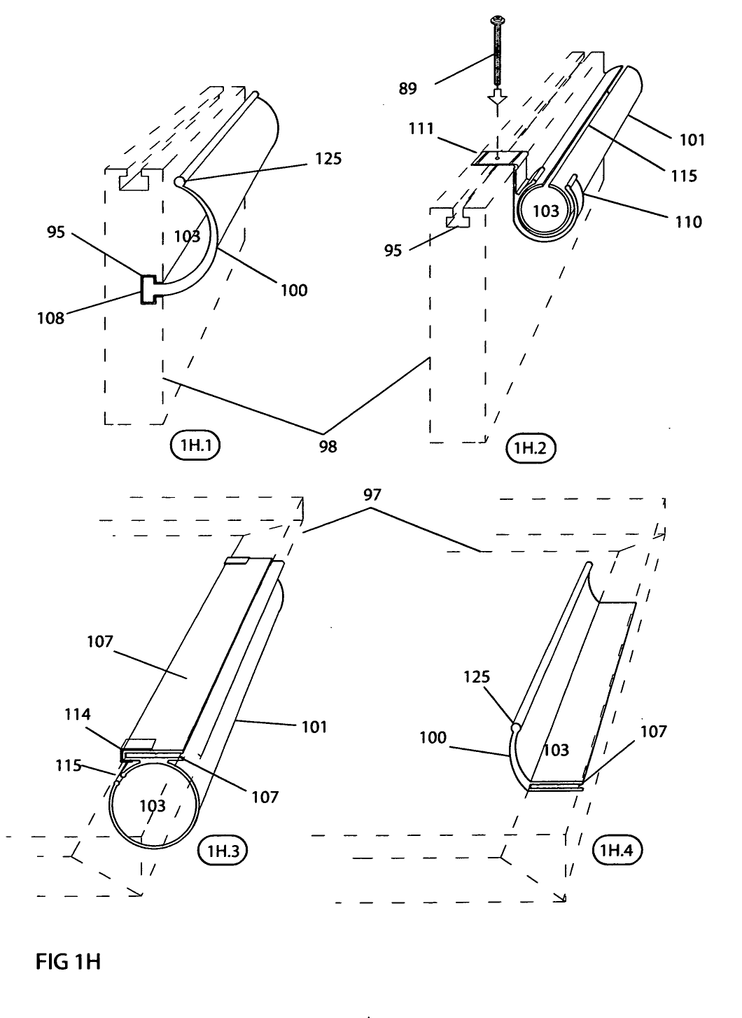

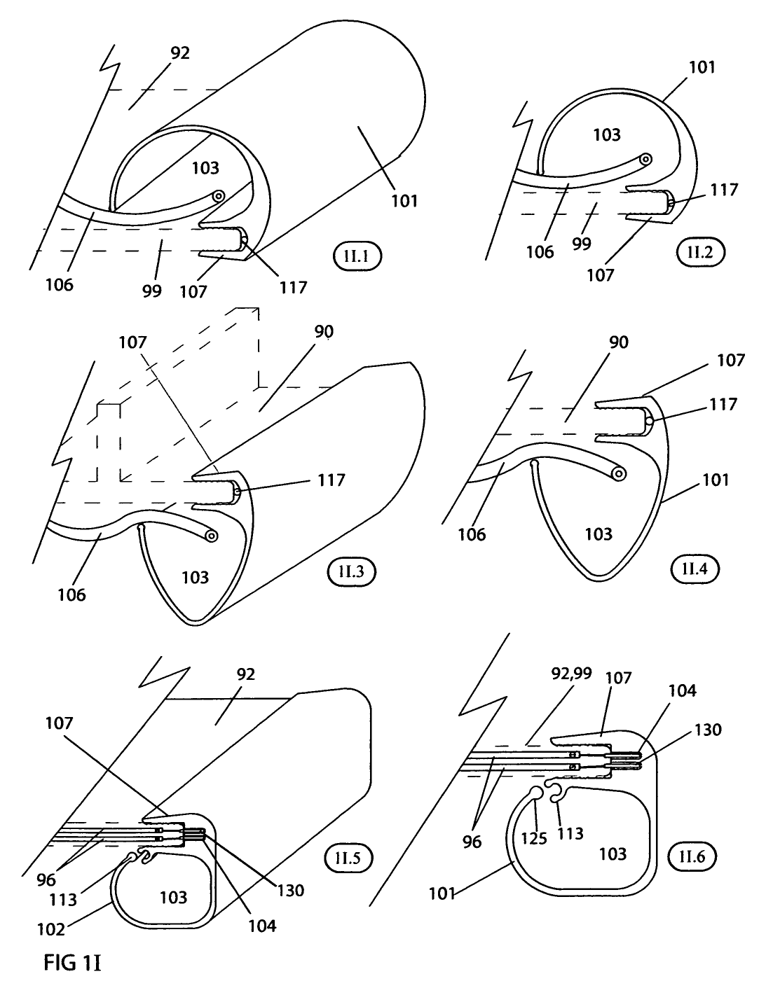

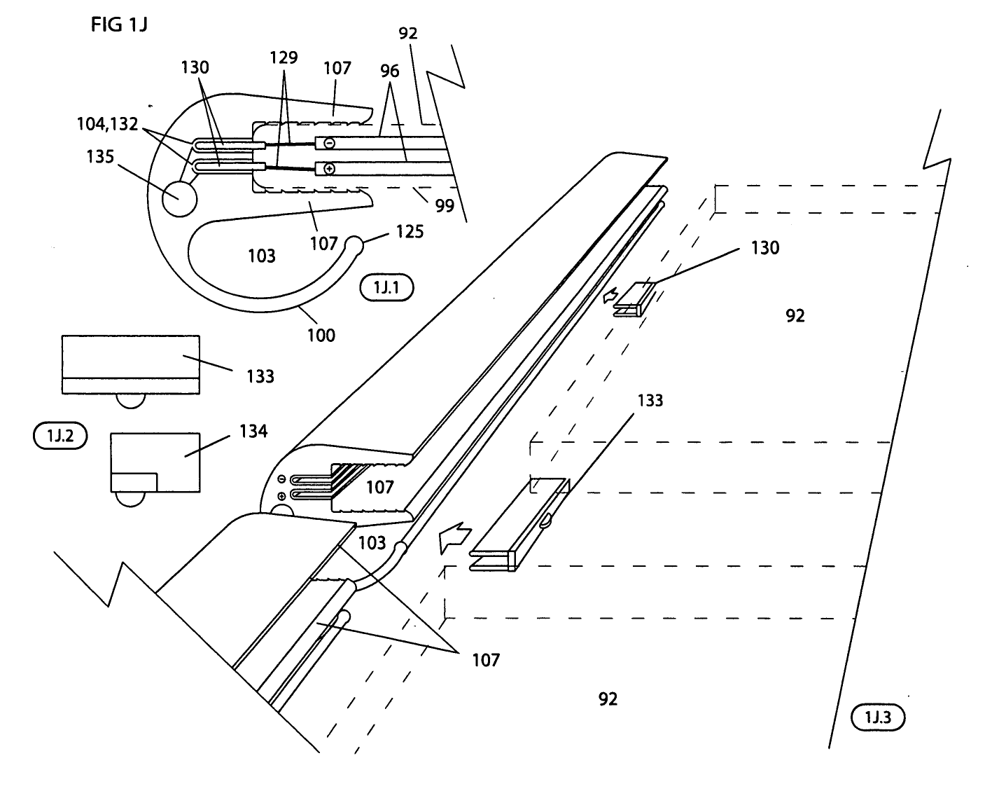

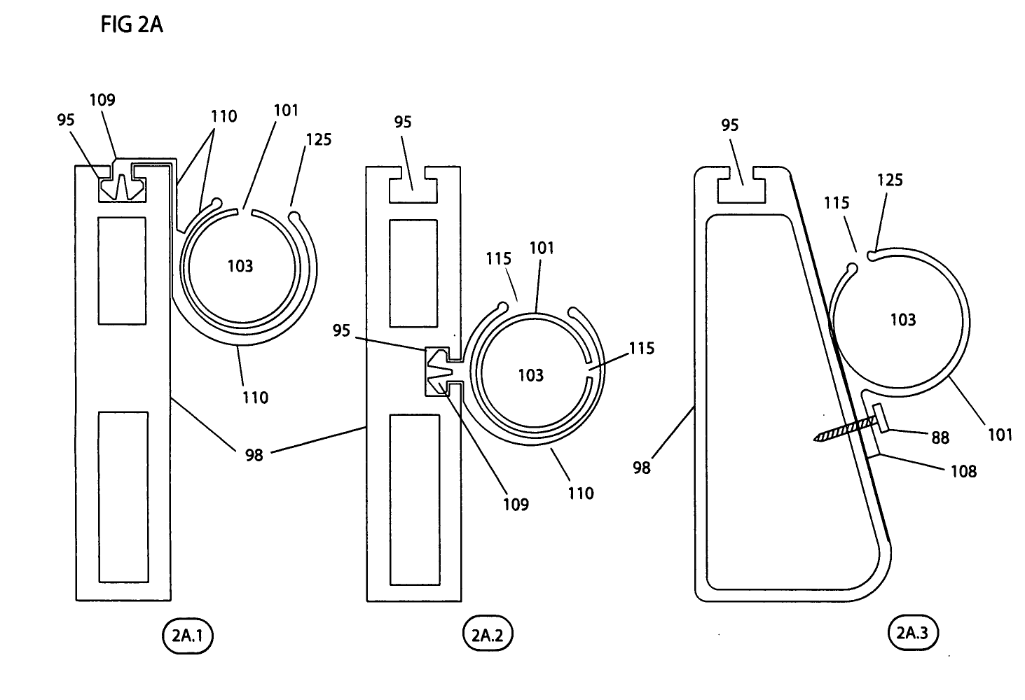

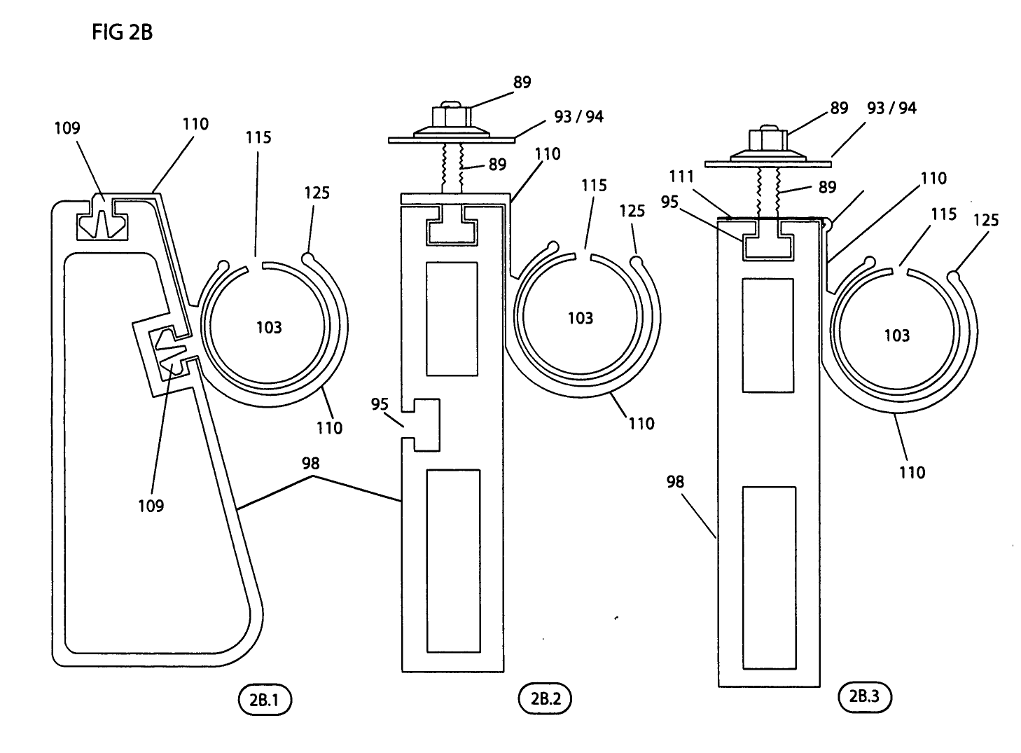

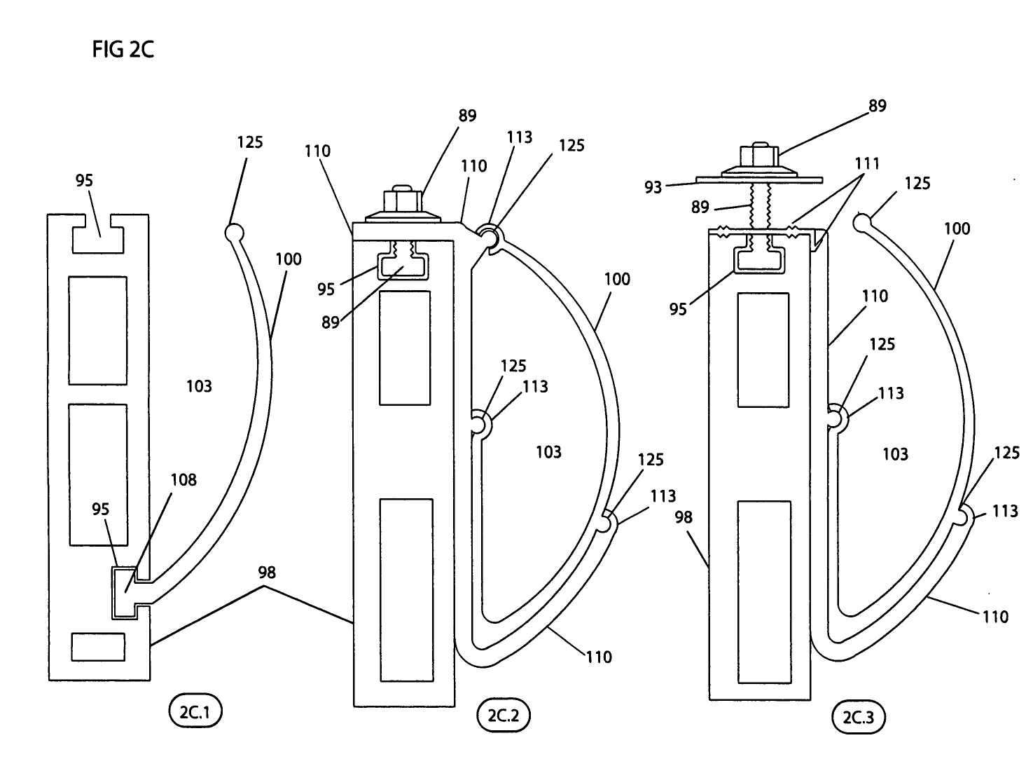

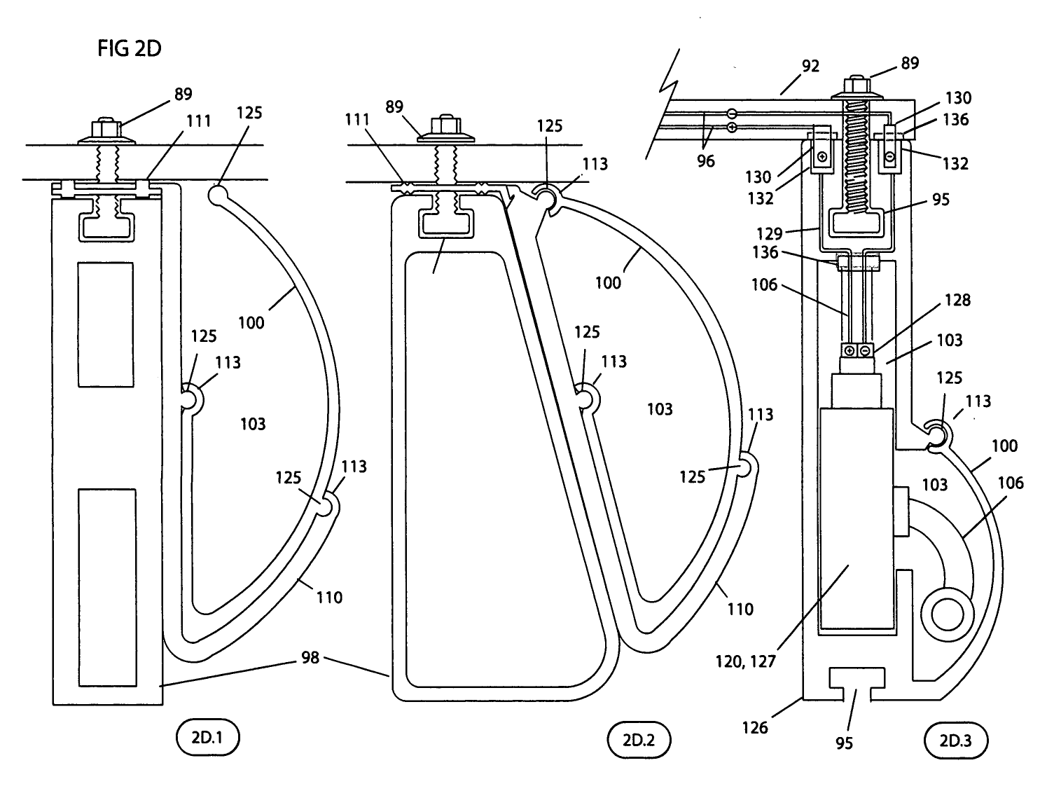

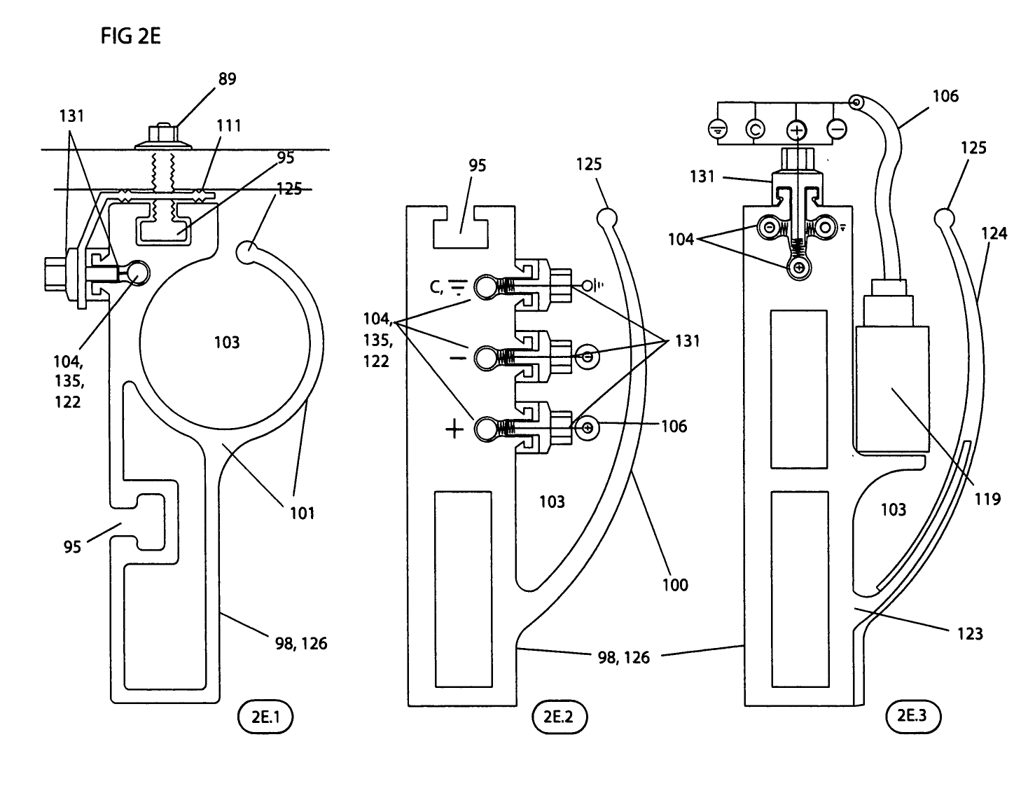

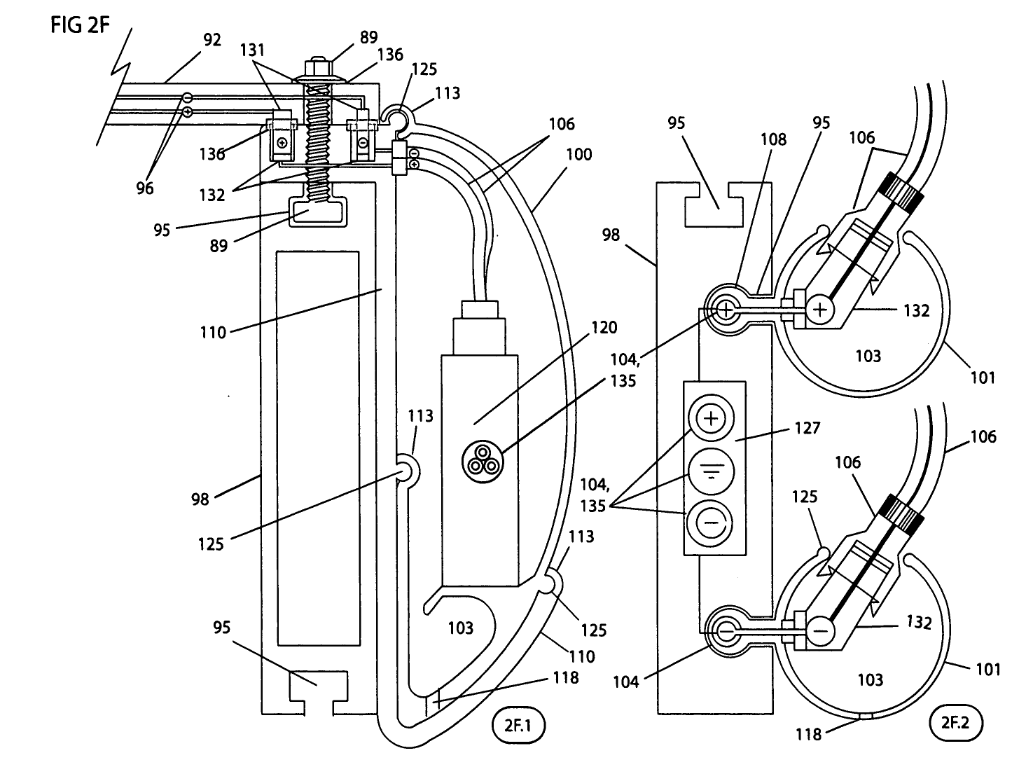

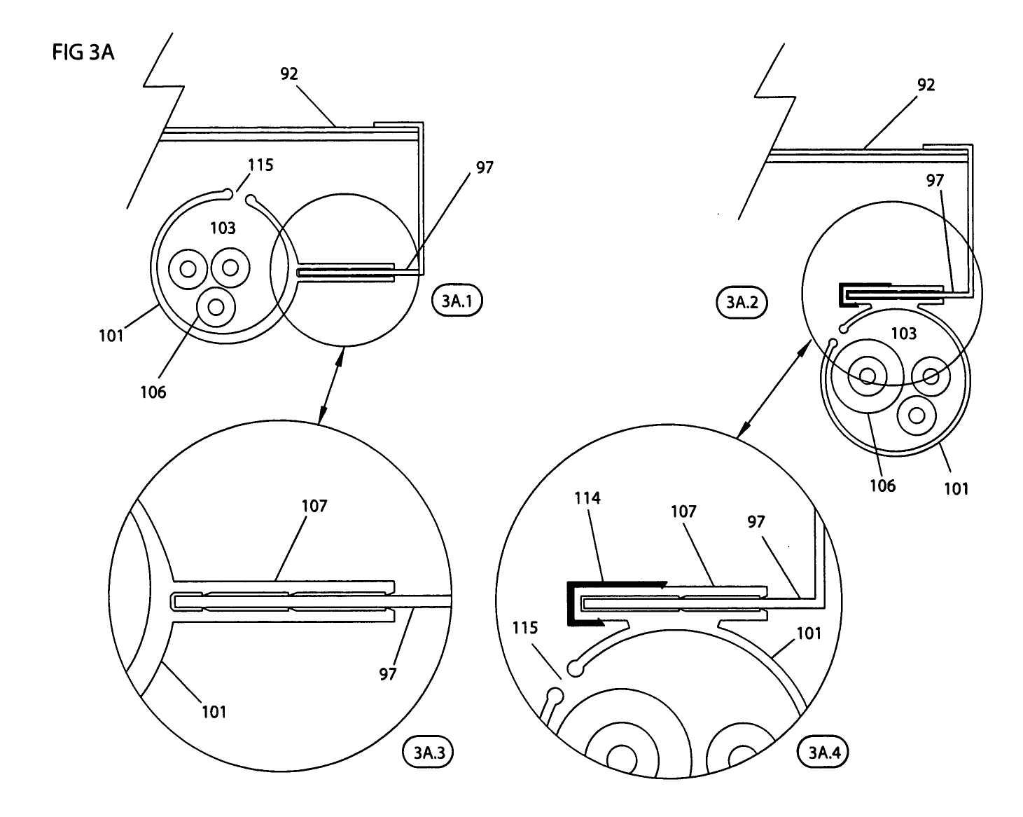

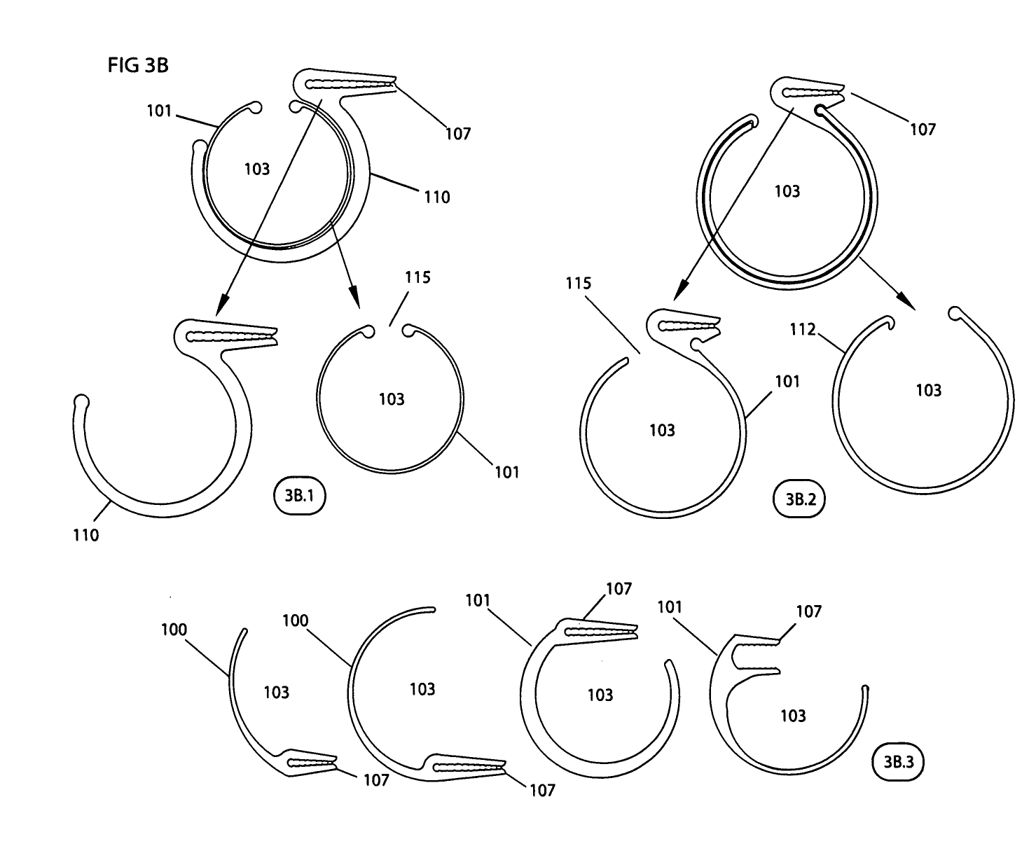

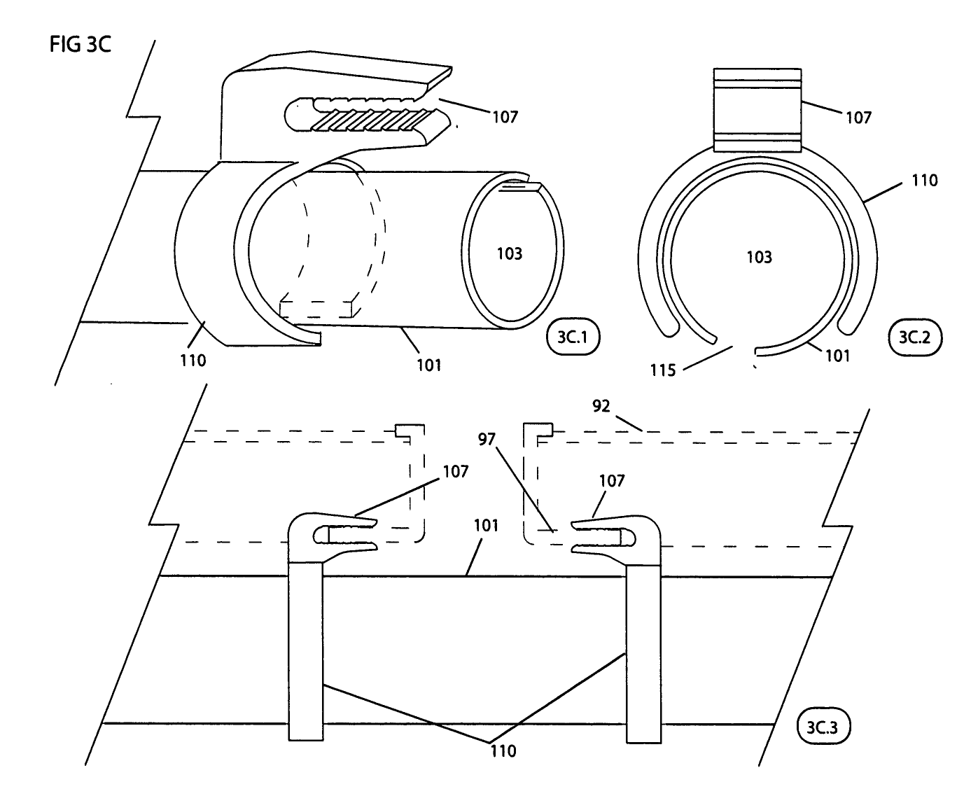

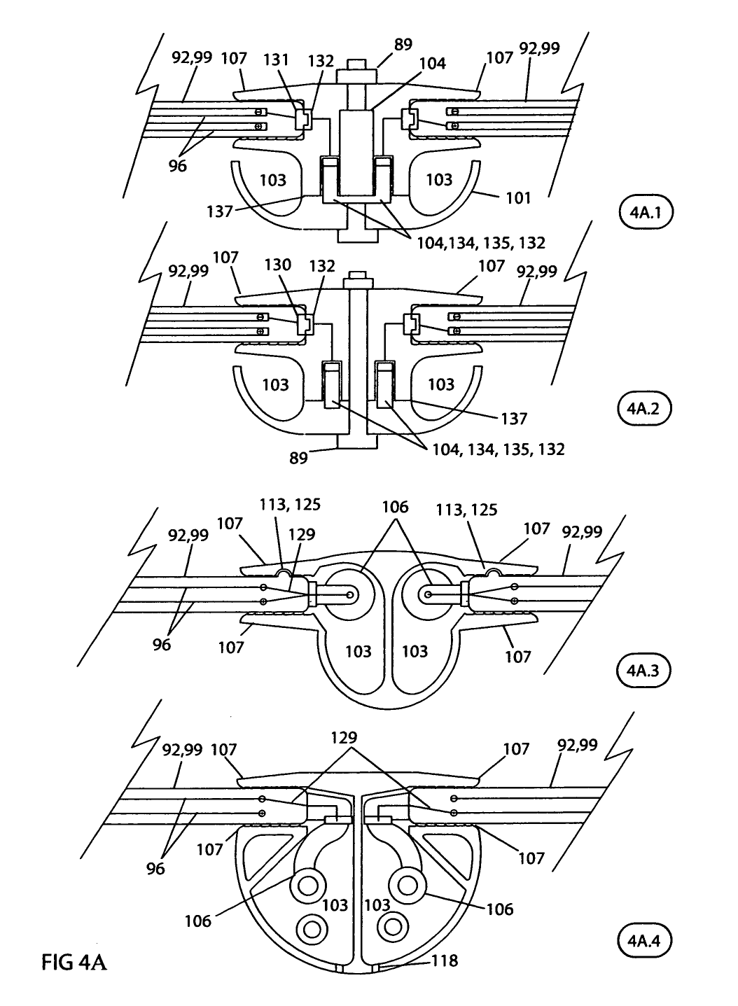

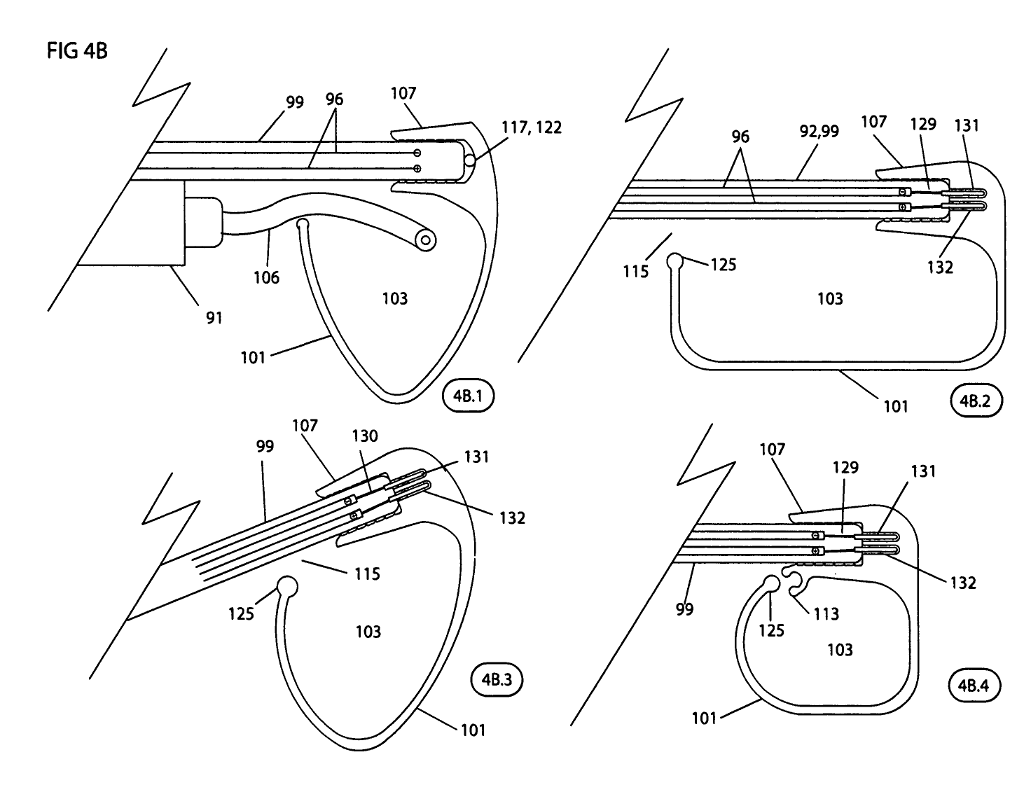

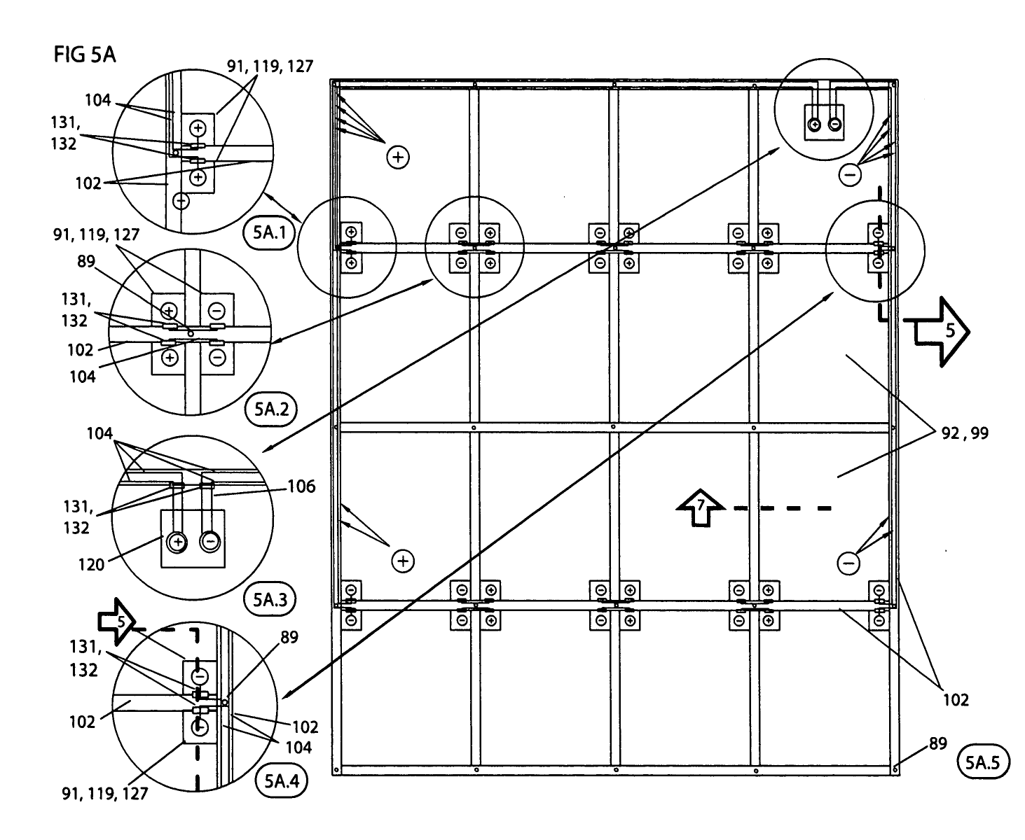

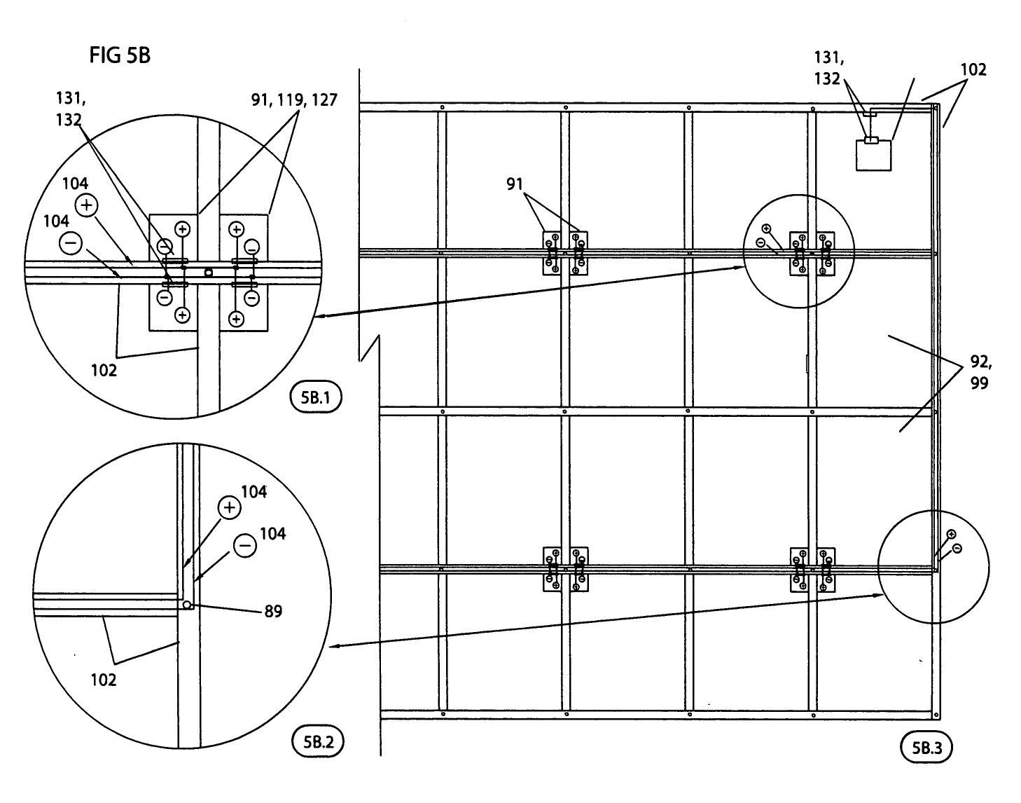

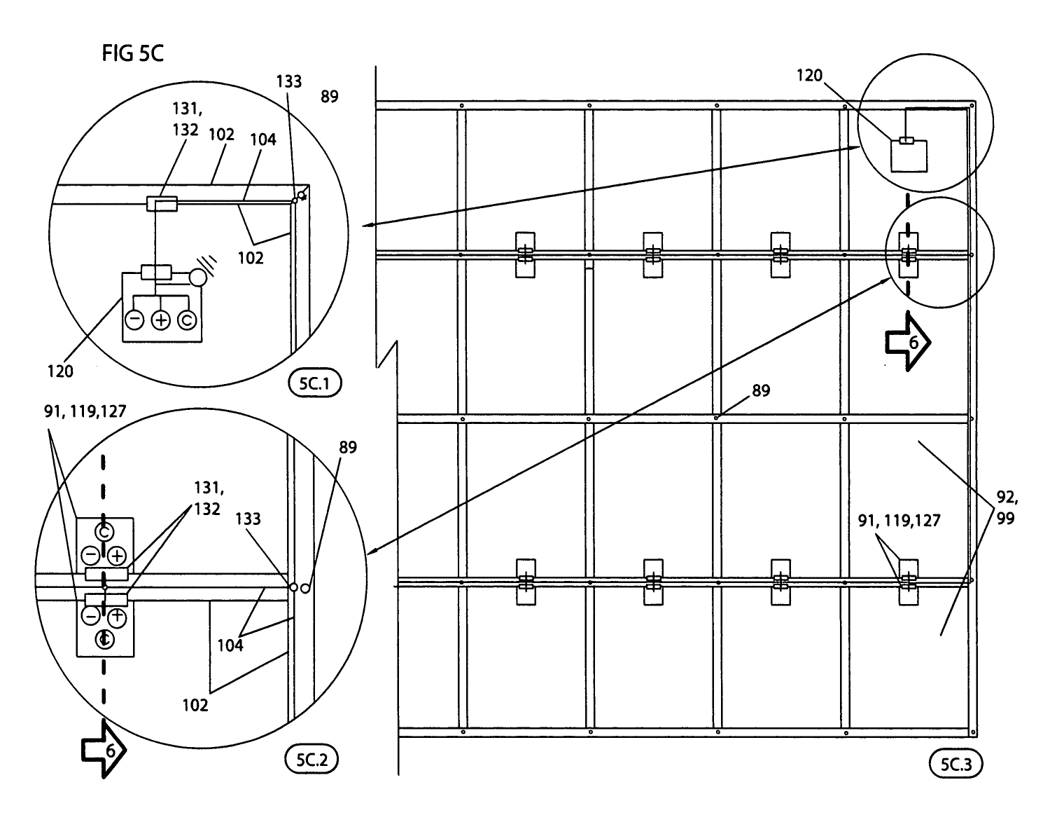

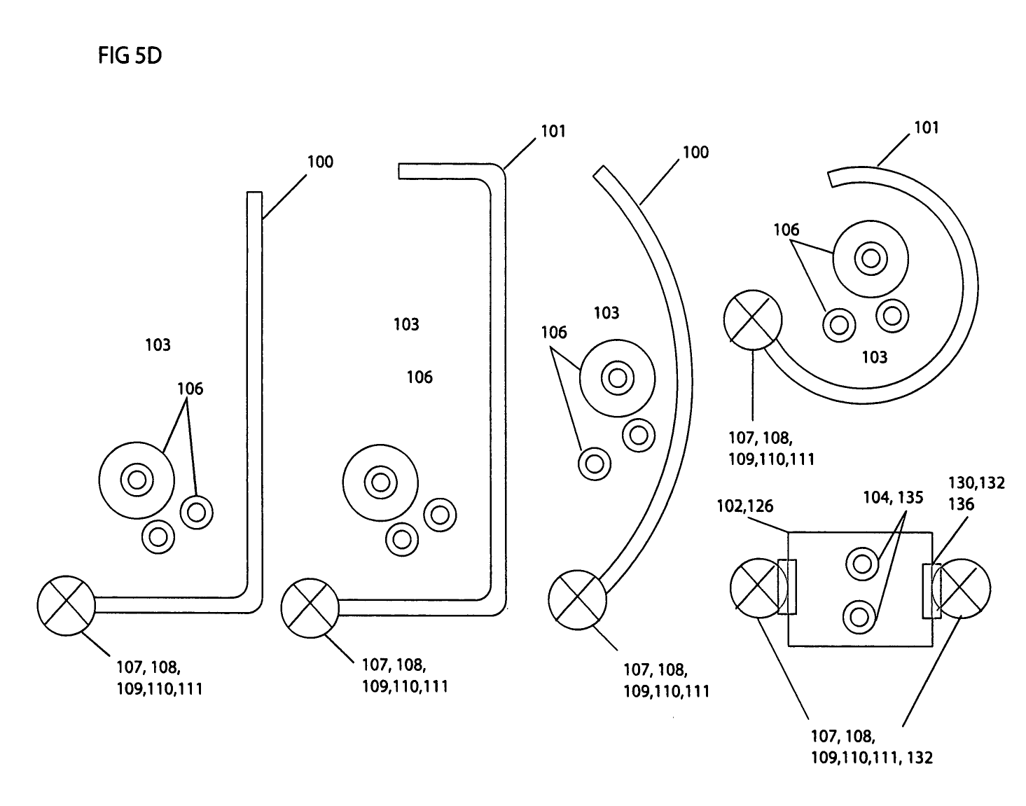

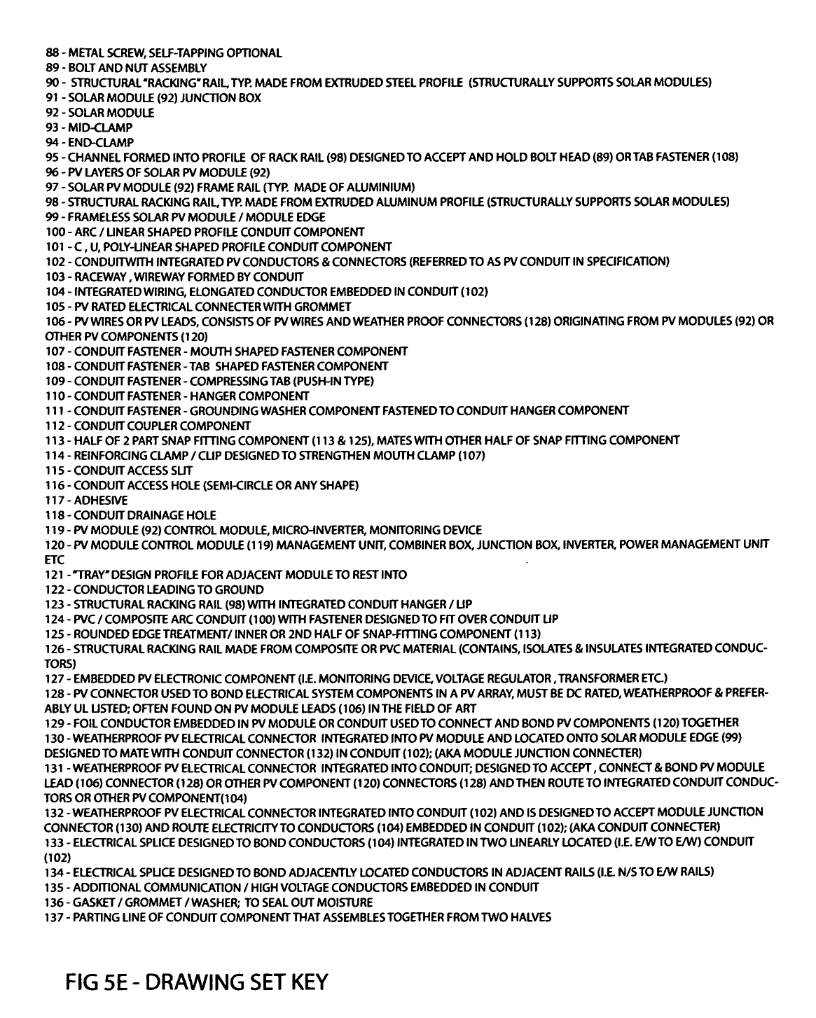

FIG. 3B depicts a section drawing of a variety of conduit models with integrated mouth shaped fasteners 107.
a) 3B.1 depicts manufacturing profiles of a conduit 101 and conduit hanger 110 model beings separated and sat side by side in elevation; where said mouth shaped fastener component 107 of the conduit is formed or extruded in a closed position so that upon opening while being pushed/installed onto a rail 97,90,99 the mouth 107 exerts a clamping force because the plastilene is flexed open and wants to return to its original form. The drawing further illustrates the nominal thickness of certain parts of the components 101,110 necessary to achieve flexibility and rigidity in the appropriate tolerances to function under duress.
b) 3B.2 depicts a similar installation scenario as 3B.1, however in this drawing the model has an integrated mouth fastener 107 profile extruded along the entire length of the conduit 101. A similarly shaped conduit 101 coupler 112 is provided that snaps snugly into place and continues the partially enclosed raceway 103 across module 92 gaps.
c) 3B.3 depicts several variations of the model, showing varying degrees of enclosure and mouth fastener 107 diameter or height to accommodate different rail 90,97 thicknesses, installation scenarios etc.

FIG. 3C depicts a conduit hanger 110 model that has the mouth fastener 107 turned ninety degrees in a perpendicular fashion. This is intended to universally attach to the module frame rails 97 of common PV modules that are perpendicular to the racking rails. This model is, of course, applicable in many installation scenarios to hang a conduit across a gap in a solar array or other areas of the industry.
a) 3C.1 is an axonometric view of said ninety-degree hanger 110 and conduit 101.
b) 3C.2 is an elevation view showing certain basic dimensions of both conduit 101 and conduit hanger 110 in relationship to each other.
c) SC.3 is a section view from viewpoint 3 showing the relationship between two hangers 110, a single conduit 101 spread over a gap between two solar modules 92.

FIG. 4A depicts four section drawings from viewpoints 5 and 6 of four different versions of conduit models 101,102,126 shown as a conduit that is designed install onto a plurality of solar modules mounted adjacently to each other. As illustrated, the conduits uses the mouth fastener 107. This fastener may be used to mount the solar module on a building façade, and mate with said building façade. The conduits illustrated work to align, mate and bond said modules together in an array form or building integrated application. The conduit may or may not have integrated conductors/connectors. If no integrated conductors are present, as in 4A.3 and 4A.4, the conduit offers a wire way for said system leads 106.
a) 4A.1 depicts a section drawing from viewpoint 6 of two adjacently located PV modules 99 with integrated conductors 130, 132 and an additional wire way 103 provided by conduit 101. The conduit is separated into two parts and may be majorly assembled from below or inside a building. The conduit may contain certain connectors 104,134,135 designed to integrate the modules and system component 120 leads 106 together.
b) 4A.2 depicts a section drawing from viewpoint 5 of two adjacently located PV modules 99 installed into one conduit 102 with integrated conductors 104 and connecter 132 and providing raceway 103.
c) 4A.3 depicts a section drawing of a conduit model from a similar viewpoint as the previous 4A.1 and 4A.2. However, this drawings illustrates a model of conduit with no integrated conductors. The conductors and connectors are integrated into the PV module 99 only. The elongated mouth fastener 107 and module 99 have one half of a snap-fitting integrated into them, so that they may mate together and secure the conduit 107 to the modules 99.
d) 4A.4 depicts a similar section drawing as 4A.3 of similar invented system hardware combinations and is meant to illustrate the variable forms of the model describe in 4A.3.

FIG. 4B illustrates four different versions of a model of conduit 101 installed onto a frameless PV module 99 with and without integrated conductors 104. The drawings on this sheet are intended to illustrate the various conduit 101 forms.

FIGS. 5A, 5B and 5C depict a plan drawing of three different solar PV arrays as seen from below the array. The drawings illustrate the variable location and circuit design of certain components of certain types of system designs using the conduit with integrated conductors as described.
a) 5A illustrates an array of modules connected in string series. The circuit of energy from the modules is illustrated being routed through the module junction box 91 connector 130 to a connector in the rail 132 through the integrated raceway 103 or conductors 104 of the conduit 101 to a junction box 120, inverter 120 or control module management unit 120. Section viewpoint 6 is illustrated as a dashed line showing the cut line with an arrow indicating the direction of view.
b) 5B illustrates an array of modules connected together using splicing connectors 133,134 and connectors 130,132 in a circuit that combines the power generated by each module 92, 99 into two main circuits (positive and negative) comprised of integrated conductors 104 or conductors embedded in the provided raceway 103. This type of array can be described as being comprised of module junction boxes 91 that may have integrated DC control modules 119 or micro-inverters 119. The cables illustrated are shown to connect to various control modules 91 or micro-inverters 91 located throughout the system in the modules 99 or integrated in the conduit 102. The cable or circuit of power generated by the array is illustrated leading directly to a power management unit 120 or inverter etc.
c) 5C illustrates an array of modules 92 connected together using splicing connectors 133,134 and connectors 130,132 in a combined circuit that combines the power generated by each module 92, 99 into one cable of multiple conductors 104 from multiple circuits including the positive, negative, neutral, ground, and communication conductors 104 necessary to the function of said PV components. This type of array can be described as being comprised of DC control modules or micro-inverters. The circuit illustrated is shown to lead to various control modules 91 or micro-inverters 91 located throughout the system in the modules 99 or conduit 102. The power generated by the array is illustrated leading directly to a power management unit 120 or inverter etc. Section viewpoint 6 is illustrated as a dashed line showing the cut line with an arrow indicating the direction of view.

FIG. 5D illustrates a simple concept drawing of the versatility of the system components. This drawing attempts to illustrate the various combination of fasteners 107,108,109,110,111 and basic conduit forms 100,101,102 with optional integrated conductors 104 135 and connectors 130,132. The basic function of the conduit invented system is to provide an integrated raceway 103 to contain and route the PV leads 106 and/or integrated conductors 104,135 in a plurality of component combinations creating a multitude of installation scenarios described and illustrated herein.

### DETAILED DESCRIPTION OF THE PREFERRED EMBODIMENTS

In describing the preferred embodiments of the invention, it is to be understood that specific terminology will be used to convey proper communication of the new and unique ideas set forth. However, the invention is not intended to be limited to this terminology. It is to be understood that each specific term used may have many synonyms that convey the same meaning in the field of the art.

Although most of the embodiments of the invention are explained and illustrated in detail, it is to be understood that the invention is not limited in its scope to the specific details and illustrations provided here-in. The invention is capable of adapting to new and unique components as they enter the marketplace of the field of art by slightly altering or re-designing the scale, dimensions, and/or profiles of certain components of the PV conduit system, specifically the conduit and fastener components described here-in.

The PV conduit system provided is designed to be easily installed and to assist in constructing a safe, aesthetically pleasing solar array in a stand alone or building integrated manner. It is an object of the present invention to provide a wire/conductor management system or integrated conduit that elevates, organizes, routes, protects, contains and/or retain the wires/conductors found in a typical solar array. In a solar PV array, this creates an organized installation in which the wires are elevated off the rooftop or ground in a neatly secured fashion using the integrated conduit.

It is further an object of the present invention to provide a conductor management system that can be easily and effectively installed on the array without altering the framing or components of the array by drilling into or scratching the anodized or galvanized metal surfaces.

To further organize and convey information regarding the invention disclosed herein, the following paragraphs are preceded by a subject heading printed in all capital letters. This subject heading summarizes the discussion topic or subject disclosed in the corresponding paragraph. This heading can also be applied to the drawing set, specifically the drawing key. The drawing key number(s) that represent said component are listed directly following said subject headings in parenthesis' and in the description paragraph directly following said component term.

ARRAY WIRES/COMPONENT CONDUCTORS/PV CONNECTORS (104,105,106): The conductors found currently in the field of art that this system integrates with and manages can be described as the conductors, wires or leads 106 that are fastened and bonded to a single or plurality of PV components that make up a solar array. These conductors are most often attached to solar modules from the factory and the wires that the installer must connect to the factory solar module wires. These wires are necessary to complete a photo-voltaic array and are commonly referred to as PV wires, module wires, trunk cables, high and low voltage conductors and/or home-runs. These wires carry the electrical current produced from the solar modules through a series of special weatherproof outdoor DC rated PV connectors 105 through and from the solar array to a combiner box(es) or junction box, inverter, micro-inverter, PV control module, power management unit etc. or any other component 120 that accepts these conductors for whatever functional purpose. In the system provided, these conductors 104 may be integrated or embedded into the conduit.

TWO-PIECE SYSTEM: This wire management system is essentially a two piece system that may be separate or integrated together into one component. This two-piece system is comprised of the conduit component 100,101,102,103 and the fastener 107,108,109,110,111 component. In addition to these components, each model may have additional and optional components described in the drawing set and specification.

CONDUIT INSTALLATION SCENARIOS/LOCATIONS ON THE ARRAY: Using the attachment hardware components of the system, the conduit is designed to be modularly mounted in an adjacent and/or parallel fashion onto the array in a multitude of scenarios or installation locations, for example:
a) A first scenario is to fasten a conduit directly onto and along the inside or interior flange of the aluminum frame rail 97 commonly integrated onto and around most solar PV modules 92 in the marketplace of the field of art (ideally near the junction box).
b) A second scenario is to fasten a conduit directly onto and running next to the “rack” or “rail” 90,98 that structurally supports the solar modules. In this scenario, the conduit is running under the array, parallel to the rail 90,98. It is understood that the fastener features may be scaled up or down to accommodate certain installation scenarios and products in the marketplace. As shown in the drawing set, the conduit is located in areas of the array (rail or module) that avoid excess exposure to precipitation and UV rays.
c) A third scenario is to fasten a conduit directly onto a “frameless” solar PV module 99. A frameless module is basically a solar panel with the frame removed. The resin or glass “back-sheet” of the panel may be clear or transparent instead of the typical white or black. This clear back-sheet allows the solar module to be used as a window or glass facade or building integrated photovoltaic (BIPV) module.
d) A fourth scenario is to fasten and mate a conduit with integrated conductors and connectors onto a frameless solar module or typical solar module in order to eliminate the need for wires, increasing aesthetic appeal and the associated additional labor of installing said wires 106.

SYSTEM DESIGN: The basic (no integrated conductors) wire management conduit 100,101 is tailor-able to the specific project array components 90,92,97,98. The installer may choose to route the wires 106 along the module supporting rail(s) using one of the models described in this document (illustrated in drawing set) or he/she may choose to install the conduit 100,101 on each individual solar PV module/panel frame 97 in a series along the array (illustrated in drawing set).

SYSTEM ADAPTABILITY: The system components are available in different designs that attach in different scenarios throughout the array. The specific hardware or components available are based upon certain scenarios that in turn depend upon certain design criteria, for example: the installer's preference, project budget, the location on the array where the installer would like to attach the conduit, the manufacturer or model of certain components in the PV array, preferred materials, whether the installer wants to hang the conduit and ground the modules to the rails in one operation (using a conduit-hanger 110 with integrated grounding washer 111 that mounts between the module and rail, thereby bonding the two together once installed.

BASIC SYSTEM INSTALLATION: After the wire management system is designed, the conduit is installed in the manner in which it was designed; using the attachment features or hardware accordingly. The PV array wires, conductors and/or connectors are located to the conduit access holes 116 or access “slit” 115, the conduit 100,101 may be flexed outward or open to accept the wires and/or connectors. The wires and connectors 106,95 are then routed into the conduit 100,101 in an organized manner (2D). The conduit is ideally installed as close to the PV module junction boxes 91 (source of module wires) as possible. After the PV conduit is installed, the installer will then thread, feed, push or route the wires 106 into the PV conduit.

INTEGRATED MODULE JUNCTION CONNECTOR (104,129,135): In a variation of one model of the system, the electrical leads originating from a PV module may be shortened and connected to a connector 130 that is mated and bonded to another connecter 132 of inverse shape embedded in the conduit 102. Connector 132 may be bonded using embedded foil or wire 129 to various conductors 104 adapted to route the electrical current to various system components 120. These embedded connectors/conductors should be designed and manufactured to existing UL listed solar electrical connectors which are designed to conduct the electricity produced from the PV array modules 92,99 and route it into an elongated conductor or wire 104 that is factory integrated or easily integrated onsite into the conduit 102.

RAIL CONDUCTOR SPLICE (133,134): In order to provide a continuous circuit, certain electrical splice connections may be necessary to bond adjacently located conductors 104 embedded in the conduit 102.

INTEGRATED PV CONNECTOR (130,131,132,133,134): It is further understood that the PV conduit 102,124,126 provided may contain integrated, pre-terminated electrical conductors with PV connectors that are designed to create a safe, weatherproof electrical bond between an assortment of PV system components using a UL listed connector, thereby forming a weather-tight, secure connection between any two of the following PV components 119,120:
a) Another adjacently located PV module
b) A PV control module
c) A DC/AC micro-inverter
d) A “home-run” conductor
e) A combiner box
f) A junction box
g) Any PV array wiring associated with the array or solar power system.

CONDUIT WITH INTEGRATED CONDUCTORS INSTALLATION: PV conduit 102 systems, conduit with integrated conductors and connectors, contains pre-terminated conductors and connectors that are designed to mate and bond certain PV connectors and/or other PV system components together. PV conduit 102 may fasten directly to the PV module 92,99 or racking rail to form a single or plurality of UL listed electrical connections. Additional grounding, communication and high voltage conductors 135 may be integrated into the conduit. The PV conduit may be scaled larger and/or have certain design features that allow for certain PV system components to be integrated or attached to the provided raceway 103 or outside surface of the PV conduit 102.

LINEAR FASHION, COUPLERS (112): Certain conduit models are designed to be butted and mounted next to one another in a linear, adjacent, modular fashion forming a wire-way, raceway or conduit.

CONDUIT PROFILE ADAPTABLITY: The conduit profiles of the invented system are designed to adapt to different racking or modules using certain and non-certain illustrated and described extrusion profiles with integrated or separate attachment features and/or hardware that work together to install a functioning wire-way. There are two major conduit profile shapes 100,101 disclosed in the preferred model of the invention. They are described as “C” 101, “arc” 100 shaped). This conductor management system can adapt according to certain project demands.

CONDUIT PROFILE SCALABILITY: It is understood that the conduit profiles of the invented system can alter slightly in scale or dimension to accommodate the future demands, dimensions and specifications of certain products coming to market in the future.

CONDUIT PROFILE SHAPE VARIATION: It is understood that the invented conduit profile may have many shapes that create the wire-way. The invention is a claiming to be a combination of said profiles and fasteners. In the preferred model of the system, there are two main shapes.
a) The first is an “arc” or “L” or linear shaped conduit 100 that uses the rail surface to create a partially enclosed wire-way.
b) The second is a “c”,“u” or “v” shaped conduit 101 that is a partially enclosed wire-way by itself.

“ARC” SHAPED CONDUIT (100): The “arc” shaped conduit 100 form creates create a raceway 103 by using an “arc” shaped conduit component. This conduit 100 extrusion profile works in combination with the surfaces of neighboring array components such as the module frames and the racking rails. The raceway is formed when the “arc” conduit is installed onto certain components of the PV array specifically the PV module(s), racking, stanchions, rails, framing and/or along the racking, module frames. The enclosure is created when the conduit is installed adjacent onto the surfaces, corners or recesses of the neighboring array components 90,98,97,92,102.

“C” SHAPED CONDUIT (101): The “c” shaped conduit provides a raceway 103 because the “c” shaped extrusion profile creates an accessible 115 raceway 103. This conduit 101 is fastened to the array and acts as raceway independently, due to the nature of the “c” shaped profile in extrusion.

CONDUIT AS COMPONENT RACEWAY: It is understood that the conduit may be scaled up to be large enough to work as a race way 103 that may contain certain PV components 120 and the associated wiring. In the future it is expected that these components will become smaller (i.e. PV control modules, micro-inverters etc) and may be embedded directly into the raceway provided or the solar module.

COMPONENT MATERIALS: All PV conduit system components are to be formed of various plastic, metal or composite materials that are known to withstand UV exposure and other extreme environmental factors well. For example PVC and ASA. In addition, each of the plastic components may include a ultra-violet (UV) coating to provide protection against the harmful effects of the ultra-violet rays. The metal components may be painted, galvanized and/or anodized etc. to further protect them.

CONDUIT ACCESS SLIT/HOLES (115,116): The conduit profiles are designed to allow wires to be inserted into the conduit at any point along its length, due to the “slit” 115 that is formed, created by the “arc” conduit 100, or by the slit 115 that is molded into or extruded into or cut along the “c” shaped conduit 101 components. All conduit models may have access holes 116 that are punched out or cut out from the conduit to allow wires 106,135 to be fed into the conduit from array electrical components 92,99,120,127. In the preferred model, these access holes 116 are semi-circle in shape and are located directly adjacent the PV module junction boxes 91 and PV leads 106, usually at the top of the conduit. It may also have no “factory cut” openings so that the installer may cut or snip or punch openings exactly where they want them for aesthetic/functionality purposes.

FASTENER HARDWARE ADAPTABILITY: Each model of conduit may be adapted to a specific location on the array where the installer prefers to route the PV wires 106 using a conduit component and an attachment feature or hardware. In the preferred model, there are four attachment methods referred to as “hanger” 110, “tab” 108, “press in tab” 109 or “mouth shaped clamp” 107. The system can be designed using many different variations of the model that are designed to attach to either the modules 92, 99, module frame rails 97 or the racking rails 98 found in most solar arrays. The major factor that will determine the wire management system design is whether the conduit will be mounted onto the frame or edge of a PV module, or whether the conduit will be mounted onto the supporting rack or rails.

FACTORY INTEGRATED CONDUIT (123,126): The conduit may be easily co-extruded into the racking or rails or module rails as illustrated in drawings 2D.3,2E.1,2E.2,2E.3. The conduit may be co-extruded, embedded, pre-assembled or integrated into the racking, rail or module components in the manufacturing setting.

MOUTH CLAMP FASTENER (107): This “mouth clamp” fastener is made using a profile that is integrated or extruded into the conduit or conduit hanger at different scales to accommodate the various dimensions of different components found in the field of art. This clamp component may also be surrounded with a single or multiple reinforcing clips 114 that are constructed of weather resistant composite or metal to further secure the conduit and/or conduit hanger component to the rail that it is being fastened to.

TAB/COMPRESSING FASTENER (108): If the installer is installing the conduit on the rails using a channel 95 that may be integrated into the manufacturers' rail 98 extrusion profiles. The tab fastener component is designed to slide or push directly into the channel 95 commonly located along most racking rails. The tab is integrated to the conduit extrusion profile or hanger profile. The tab component is then used to hang or affix the conduit to the array.

62. CONDUIT HANGER (110): The independent hanger component is designed to cradle and secure the conduit to the array. The hanger component can be fastened using said system fasteners and/or additional hardware like screws 88 or bolts 89. The hanger 110 can accommodate multiple types of existing conduits in the field, and an ever expanding range of rail manufacturer's models.

63. CONDUIT HANGER (110) WITH GROUNDING WASHER (111): The grounding hanger component can effectively ground PV modules to module mounting rails using an integrated, thin conducting metal washer that is textured and upon compression, scratches the finish coating typically found on an aluminum PV module frame and it supporting rail, thereby establishing a conductive bond between the two metal components of a typical PV array. The conduit hanger 110 with integrated grounding washer 111 can effectively perform two tasks in the construction of a PV array, grounding the PV modules 92,99 to the racking 90,98 and cradling/clasping the PV conduit 100,101,102.

ADDITIONAL HARDWARE (88,89): Each of the conduit-like components may be installed with structurally enhancing hardware like retaining clips, screws etc to work in combination with the conduit to secure the conduit to the array. All of the conduit models may be installed by simply attaching the conduit components to the array, rails or underneath the module frames by using cable ties or by securing them with other mechanical fasteners commonly used in the associated trades.

ADHESIVES (117): Certain adhesives may be used to assist in long term bonding between conduit fasteners and certain rails of the installation scenario.

CONDUIT WITH CABLE TIE ADAPTER: The various conduit profiles may be retro-fitted with an integrated component that allow a single or plurality of cable ties to be fed through the adapter (or holes punched in conduit) and then wrapped around a large variety of rails/racking commonly used in the industry.

These together with other objects and advantages which will become subsequently apparent reside in the details of the construction and operation as more fully described and claimed, reference being had to the accompanying drawings forming a part hereof, wherein like numerals refer to like parts throughout.

What is claimed:

1. A solar photo-voltaic (PV) conductor management system consisting any combination of a plurality of provided components that are described as conduits, conduit hangers, fasteners, integrated PV conductors and any associated PV connectors that are designed to integrate together a system in order to provide a raceway on or in a solar power array using said components of varying scale and dimension depending upon certain design criteria specifically but not limited to the racking dimensions, racking extrusion profiles, solar module frame dimensions, conductor sizing and quantity, and the design of said solar power system specifically the type of power management units that interface, monitor and convert the power generated by the solar PV modules of the solar PV array to a usable form, usually inverting the solar electricity to alternating current (AC) waveform from direct current (DC) waveform generated by the PV modules.

2. A system of claim 1 comprising two necessary components having certain illustrated and un-illustrated design elements, an elongated or integrated “conduit” component, and a “fastener” component that are designed to integrate into one another and work together to create a solar PV wire management system that is able to install in a plurality of scenarios on a solar PV array, specifically the aforementioned “racking”, “rails”, “solar module frames” and/or onto the edges of a “frameless” solar module;
using provided conduit and fastener components that are specifically shaped to integrate into one another and function together as a single-part or multi-part unit, wire-way, race-way.
using provided fastener components that are designed to integrate with and attach the conduit or conduit hanger components to certain components of a solar power array.
using provided conduit components that are designed to provide or integrate a raceway or wire-way onto a solar powerarray.

3. A system of claim 1 that is adaptable to a variety of solar power systems using the assortment of provided conduits, conduit hangers, fasteners, connectors, and integrated conductors that are designed to be interchanged, combined and fastened onto said solar power module or array and adapt to a variety of solar power system components found in the current or future marketplace of the field of the solar power.

4. A conduit component of claim 1 using certain linear, poly-linear, “arc” , “c” , “J” , “L” or other poly linear shaped extrusion profiles that are designed to install and work in conjunction with certain surfaces of the array, specifically the racking and modules of a solar array to form a fully or partially enclosed race-way that is majorly accessible along its length.

5. A conduit hanger component of claim 1 that is designed to work as a hanger that cradles, supports, fastens or integrates to the various conduit components of the system provided.

6. A fastener of claim 2 that is mouth-like in nature and is designed or shaped to press, clamp or fasten around and onto certain framing, rails, racking extrusion profiles, “frameless” solar module edges, rails or solar module frames and integrate with said conduit or conduit hanger. as a single extruded component or the fastener can integrate into a hanger for the conduit component.

7. A conduit hanger of claim 5 that is designed to be integrated with the mouth shaped fastener of claim 6 turned ninety degrees perpendicular to open portion of the hanger as to provide a conduit between the gap of two adjacently mounted modules or arrays.

8. A fastener of claim 2 that is described as a tab fastener and is designed to be identical in profile of the racking rail channel it will be inserted to, but it must be slightly smaller in scale as to allow easy insertion and sliding into and down a variety of channels commonly extruded in an assortment of racking profiles found in the field of art.

9. A fastener of claim 7 that is altered slightly in scale and shape as to easily insert ,in a perpendicular fashion, into a variety of racking rail channels by pressing the tab into said channel at a plurality of locations along the length of the channel using a collapsible tab that collapses upon insertion and expands to structural fasten said conduit or conduit hanger to the racking rail of said array.

10. A grounding washer that is designed to integrate with said conduit hanger of claim 5 and work together to mount directly between a single or plurality of aluminum solar module frames and the adjacent aluminum mounting rails or structural racking of a solar array, thereby effectively electrically bonding the plurality aluminum components together and simultaneously providing a hanger to support the conduit between spans of ideally two module lengths.

11. A grounding conduit hanger of claim 9 with certain design features embedded on the grounding washer component that are designed to penetrate the anodized, galvanized or enamel coatings on the adjacent metal array components upon being clamped between the two metal surfaces to create a secure electric bond for grounding or conduction purposes.

12. A grounding conduit hanger of claim 9 that has a hole centrally located on the grounding washer component of the hanger which is designed to allow passage of a “mid-clamp” bolt or “end-clamp” bolt that is commonly used to install the clamps that are used to secure solar modules down to the respective supporting rails in a solar photovoltaic array.

13. A provided conductor management system that may be integrated, attached, fastened, embedded and/or co-extruded into the racking or module components of a solar array in the manufacturing environment, prior to onsite installation;
by fastening the conduit to the array components using the fastening hardware designs provided here-in.
by integrating the provided conduit or variations thereof with array racking during the manufacturing, extrusion or assembly process.
by embedding or integrating the conduit using other manufacturing methods considered practical in the related fields of the art.
using roll forming methods or other manufacturing molding or forming techniques considered obvious and practical in the related fields of the art.

14. A conductor management system of claim 12, which works to embody certain integrated conductors, wires, and connectors that may be embedded, coextruded and/or pre-terminated in the conduit raceway or PV module and are used to route, control, invert and/or monitor the electrical current or power produced by the solar modules .

15. A solar wire-management system, wherein an integrated conduit and fastener component may be made using a design that is engineered to be manufactured from a flexible material as to be collapsible or flexible enough to be packaged in a “reel”, which is a rolling circular method of packaging.

16. A conductor management system of claim 12 wherein the components of the system may be manufactured from various plastics, composites, metals and natural materials known to withstand the elements that solar power systems encounter such as but not limited to polyvinyl chloride (PVC), acrylonitrile styrene acrylate (ASA), stainless steel, galvanized or anodized aluminum, galvanized steel, anodized steel, and/or bamboo.

17. A conductor management system of claim 12 wherein said system components are illustrated in simple terms to convey their primary function and may be altered, re-designed and engineered to contain certain embodiments necessary to the component, specifically the size and shape of provided components such as the conduits, hangers, fasteners, conductors, connectors, splices, gaskets and integrated circuitry or other PV system components.

18. A system of conduit with integrated fasteners wherein said system is made up of a plurality of conduit-like components that may fit into one another and be fastened to one another in a linear or perpendicular fashion, using illustrated and un-illustrated couplings or additional hardware.

19. A solar conductor management system that is designed, engineered, and constructed to pass all U.L. certification requirements, nationally and internationally, and any other regulatory/certification requirements, registrations and listings.

20. A solar power component and wire management system, wherein said system is designed to be ever expanding and adaptable in order to be compatible with current and future PV system components available in marketplace of the field of the art.
